(19) United States
(12) Patent Application Publication
(10) Pub. No.: US 2022/0301119 A1
(43) Pub. Date: Sep. 22, 2022

(54) IMAGE PROCESSING DEVICE, IMAGE PROCESSING METHOD, PROGRAM, AND IMAGE PROCESSING SYSTEM

(71) Applicant: SONY GROUP CORPORATION, Tokyo (JP)

(72) Inventor: Shunichi HOMMA, Saitama (JP)

(73) Assignee: SONY GROUP CORPORATION, Tokyo (JP)

(21) Appl. No.: 17/635,539

(22) PCT Filed: Sep. 11, 2020
(86) PCT No.: PCT/JP2020/034435

§ 371 Date: Feb. 15, 2022

(30) Foreign Application Priority Data
Sep. 25, 2019 (JP) 2019-174414

(51) Int. Cl. G06T 5/00; G06T 7/60; G06T 7/33; G06T 7/73; G06T 7/11; G06T 17/00

(52) U.S. Cl. CPC G06T 5/006; G06T 7/60; G06T 7/33; G06T 7/73; G06T 7/11; G06T 17/00; G06T 2207/30176; G06T 2207/30196

(57) ABSTRACT

There is provided an image processing device, an image processing method, a program, and an image processing system capable of generating an image for accurately creating a 3D model on a server side by avoiding leakage of privacy information. A control unit searches an image among a plurality of images in which the same subject is captured, in which the image is a target of processing of searching for a concealment area that is an area to be concealed in the image, for the concealment area in which an area common to the concealment area that has been detected is to be concealed in the image for which concealment processing to conceal the concealment area has already been performed, and synthesizes, when a concealment processing image including a unique texture is synthesized with the concealment area that has been found from the image as the processing target, the concealment processing image that is the same as the concealment processing image synthesized by concealment processing on the concealment area that has been detected, with the concealment area in the image as the processing target in which an area common to the concealment area that has been detected is to be concealed. The present technology can be applied to a smartphone or the like that performs image processing of concealing information in an image.

### TECHNICAL FIELD

The present technology relates to an image processing device, an image processing method, a program, and an image processing system, and more particularly relates to an image processing device, an image processing method, a program, and an image processing system capable of generating an image for accurately creating a 3D model on a server side by avoiding leakage of privacy information.

### BACKGROUND ART

Conventionally, a technique has been achieved in which an image of a subject is captured from various positions using a mobile device such as a smartphone, and a 3D model (three-dimensional information indicating a three-dimensional shape of the subject) is created using a group of images acquired by the image-capturing.

For example, Patent Document 1 discloses a technique for efficiently generating an environment map reflecting three-dimensional data of various objects on the basis of an image acquired by one camera.

Incidentally, since creation of the 3D model requires abundant calculation resources, a process of transmitting the group of images from the mobile device to an external calculation server and creating the 3D model in the external calculation server may be performed. However, in a case where a group of images is transmitted to the external calculation server in order to create the 3D model, there is a concern that an image in which privacy information is captured is transmitted, and a technique for protecting the privacy information is required.

Accordingly, as disclosed in Patent Documents 2 to 5, various techniques have been proposed in which image processing is performed on the privacy information captured in the group of images to achieve protection of the privacy information.

### CITATION LIST

### Patent Document

Patent Document 1: Japanese Patent Application Laid-Open No. 2008-304268
Patent Document 2: Japanese Patent Application Laid-Open No. 2014-207541
Patent Document 3: Japanese Patent Application Laid-Open No. 2015-005972
Patent Document 4: Japanese Translation of PCT International Application Publication No. 2016-532351
Patent Document 5: Japanese Patent Application Laid-Open No. 2016-007070

### SUMMARY OF THE INVENTION

### Problems to be Solved by the Invention

However, in an image subjected to the image processing for protecting the privacy information, in a case where texture or geometric information necessary for creation of the 3D model is lost from the image, it is assumed that it becomes difficult to create the 3D model with high accuracy on the server side.

The present technology has been made in view of such a situation, and enables generation of an image for accurately creating a 3D model on the server side by avoiding leakage of privacy information.

### Solutions to Problems

An image processing device according to one aspect of the present technology includes a control unit that searches an image among a plurality of images in which a same subject is captured, in which the image is a processing target that is a target of processing of searching for a concealment area that is an area to be concealed in the image, for the concealment area in which an area common to the concealment area that has been detected is to be concealed in the image after concealment processing for which concealment processing to conceal the concealment area has already been performed, and synthesizes, when a concealment processing image including a unique texture is synthesized with the concealment area that has been found from the image as the processing target, the concealment processing image that is the same as the concealment processing image synthesized by concealment processing on the concealment area that has been detected, with the concealment area in the image as the processing target in which an area common to the concealment area that has been detected is to be concealed.

An image processing method or a program according to one aspect of the present technology includes searching an image among a plurality of images in which a same subject is captured, in which the image is a processing target that is a target of processing of searching for a concealment area that is an area to be concealed in the image, for the concealment area in which an area common to the concealment area that has been detected is to be concealed in the image after concealment processing for which concealment processing to conceal the concealment area has already been performed, and synthesizing, when a concealment processing image including a unique texture is synthesized with the concealment area that has been found from the image as the processing target, the concealment processing image that is the same as the concealment processing image synthesized by concealment processing on the concealment area that has been detected, with the concealment area in the image as the processing target in which an area common to the concealment area that has been detected is to be concealed.

In one aspect of the present technology, an image among a plurality of images in which a same subject is captured, in which the image is a processing target that is a target of processing of searching for a concealment area that is an area to be concealed in the image, is searched for the concealment area in which an area common to the concealment area that has been detected is to be concealed in the image after concealment processing for which concealment processing to conceal the concealment area has already been performed, and when a concealment processing image including a unique texture is synthesized with the concealment area that has been found from the image as the processing target, the concealment processing image that is the same as the concealment processing image synthesized by concealment processing on the concealment area that has been detected is synthesized with the concealment area in the image as the processing target in which an area common to the concealment area that has been detected is to be concealed.

### BRIEF DESCRIPTION OF DRAWINGS

FIG. 1 is a diagram illustrating a configuration example of an image processing system according to one embodiment of the present technology.

FIG. 2 is a sequence diagram illustrating an overall flow until start of service provision using a 3D model.

FIG. 3 is a block diagram illustrating a hardware configuration example of a smartphone.

FIG. 4 is a block diagram illustrating a functional configuration example of the smartphone.

FIG. 5 is a block diagram illustrating a configuration example of a concealment processing unit.

FIG. 6 is a diagram illustrating examples of captured images.

FIG. 7 is a diagram illustrating an example of a method of estimating a geometric transformation parameter.

FIG. 8 is a diagram illustrating an example of a table stored in a concealment processing database.

FIG. 9 is a diagram illustrating examples of concealment areas masked by concealment area masks.

FIG. 10 is a diagram illustrating another example of a table stored in the concealment processing database.

FIG. 11 is a diagram illustrating an example of synthesis of a concealment processing image.

FIG. 12 is a flowchart describing image acquisition processing #1.

FIG. 13 is a flowchart describing three-dimensional reconstruction image database creation processing #1.

FIG. 14 is a flowchart describing concealment processing #1.

FIG. 15 is a flowchart describing detected concealment area search processing #1.

FIG. 16 is a block diagram illustrating a configuration example of the smartphone.

FIG. 17 is a block diagram illustrating a configuration example of the concealment processing unit.

FIG. 18 is a diagram illustrating an example of a method of searching for a concealment area corresponding to a concealment area that has been detected using a camera posture.

FIG. 19 is a diagram illustrating an example of a table stored in the concealment processing database.

FIG. 20 is a diagram illustrating another example of a table stored in the concealment processing database.

FIG. 21 is a diagram illustrating still another example of the table stored in the concealment processing database.

FIG. 22 is a flowchart describing image acquisition processing #2.

FIG. 23 is a flowchart describing three-dimensional reconstruction image database creation processing #2.

FIG. 24 is a flowchart describing detected concealment area search processing #2.

FIG. 25 is a diagram illustrating a method of estimating a geometric transformation parameter using a text area.

FIG. 26 is a flowchart describing concealment processing #3.

FIG. 27 is a flowchart describing detected text area search processing.

### MODE FOR CARRYING OUT THE INVENTION

Hereinafter, a mode for carrying out the present technology will be described. The description will be made in the following order.

1. Outline of image processing system

2. Configuration of smartphone

3. Operation of smartphone

4. Example using camera posture

5. Example using text area

6. Others

<1. Outline of Image Processing System>

First, an outline of an image processing system to which the present technology is applied will be described.

The image processing system to which the present technology is applied is used for, for example, a service using a 3D model provided by an e-commerce site that sells products on a website on the Internet. The user can use services using various 3D models, such as a simulation service of furniture arrangement provided by an e-commerce site and a confirmation service of a carry-in route of large furniture, on the basis of the 3D models of his or her own room or home.

In this case, there are following two methods as a method of creating a 3D model required for a service using a 3D model.

1. First method in which the user himself or herself creates a 3D model and provides the 3D model to the e-commerce site

2. Second method in which a calculation server on the e-commerce site side creates the 3D model on the basis of a group of images of the own room or home provided by the user.

For example, in the first method, since the group of images used for creating the 3D model is not transmitted to the e-commerce site, naturally, the privacy information will not be read. Furthermore, when the 3D model is provided to the e-commerce site, the effect of privacy protection can be obtained by removing color information and texture information from the 3D model.

However, it is difficult to create the 3D model with a mobile device such as a smartphone, for example, because creation of the 3D model requires quite large calculation resources. Therefore, it is conceivable that providing the service using the 3D model is difficult by the first method.

On the other hand, in the second method, the group of images captured by the user is transmitted to the calculation server of the e-commerce site in order to create the 3D model. Then, the calculation server creates the 3D model of the user's room on the basis of the received group of images, and registers the 3D model in a database for providing the service using 3D models.

At this time, there is a possibility that privacy information is included in the group of images captured by the user, and it is necessary to perform concealment processing on the user side before transmitting the group of images to the calculation server.

Accordingly, in the following, an example will be described in which, in a case where the service using the 3D model created by the second method is provided, an image is generated that enables to accurately create the 3D model while protecting the privacy of the user.

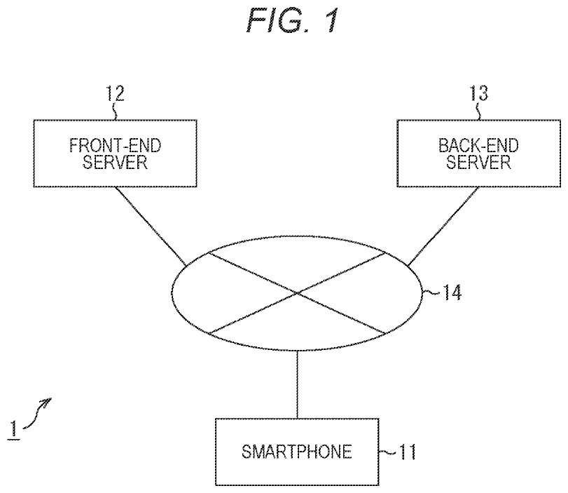

FIG. 1 is a diagram illustrating a configuration example of an image processing system according to one embodiment of the present technology.

An image processing system 1 of FIG. 1 includes a smartphone 11, a front-end server 12, and a back-end server 13. The smartphone 11, the front-end server 12, and the back-end server 13 are each connected via a network 14 such as the Internet or a local area network (LAN).

The smartphone 11 is a mobile terminal of a user who uses the e-commerce site. The front-end server 12 and the back-end server 13 are, for example, servers managed by a business operator who operates the e-commerce site. Note that the user may use the e-commerce site using, for example, various terminals having an image-capturing function, such as a tablet terminal and a personal computer, instead of the smartphone 11.

For example, the user at home can use the service using the 3D model as described above by providing an image obtained by capturing an image of the state of the room to the e-commerce site side.

The smartphone 11 captures an image of the state of a room and acquires the captured image according to an operation of the user. The image-capturing using the smartphone 11 is repeatedly performed a plurality of times. In each image captured by the smartphone 11, various objects such as a wall and a window of a room and small items placed in the room are captured as subjects.

Therefore, for example, in a case where privacy information is captured in these images, an area in which the privacy information is captured should be concealed before transmission via the network 14.

Thus, the smartphone 11 detects a concealment area appearing in the captured image. The concealment area is an area in which it is conceivable that information to be concealed such as privacy information appears in the entire captured image.

For example, the smartphone 11 detects a text area, which is an area including a text describing privacy information is described, and an area to which a semantic label is given as privacy information, as the concealment area. The text area includes an area where a letter, a postcard, a document, a document displayed on the display appear, and the like. Furthermore, the area to which the semantic label is given includes, for example, an area where a window appears. That is, it can be said that the semantic label is given to the area where a window appears as an area to be concealed from the viewpoint that the address of the user may be identified from the scenery outside the window.

Then, the smartphone 11 performs concealment processing of synthesizing a concealment processing image as described later with the concealment area on the captured image, and transmits an image after the concealment processing obtained by performing the concealment processing to the front-end server 12. Note that the concealment processing may be performed by a device different from the device that performs image-capturing. For example, the captured image acquired by the smartphone 11 may be transmitted to a personal computer, and the concealment processing on the captured image as the processing target may be performed by the personal computer.

The front-end server 12 receives the image after the concealment processing transmitted from the smartphone 11, and transmits the image after the concealment processing to the back-end server 13. At this time, the front-end server 12 transmits a request for creating a 3D model to the back-end server 13 together with the image after the concealment processing.

The back-end server 13 is, for example, a calculation device having abundant calculation resources. Then, in response to the request transmitted from the front-end server 12, the back-end server 13 creates the 3D model using the image after the concealment processing. As described above, in a case where the state of the room of the user is being image-captured, a 3D model representing the state of the room is created. For example, a method of generating an environment map reflecting such a 3D model is disclosed in detail in Patent Document 1 described above.

Note that the functions of the front-end server 12 and the back-end server 13 may be implemented by one server.

In the image processing system 1, a service using the 3D model as described above is provided to the user using the 3D model created in this manner. At this time, since the 3D model is created on the basis of the image in a state where the privacy information related to privacy of the user is concealed, the privacy information is also concealed in the room of the user represented by the 3D model.

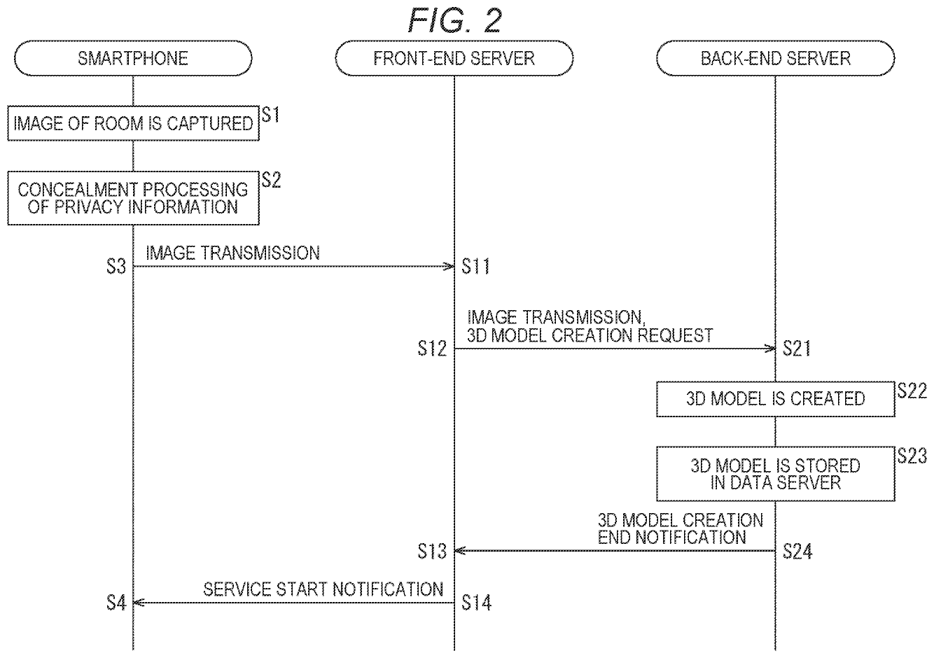

FIG. 2 is a sequence diagram illustrating an overall flow from image-capturing by a user to start of service provision using the 3D model in the e-commerce site.

In step S1, for example, the smartphone 11 captures an image of a three-dimensional space such as a room from different positions a plurality of times and acquires a plurality of captured images.

In step S2, the smartphone 11 performs the concealment processing of concealing privacy information appearing in the plurality of captured images. By performing the concealment processing, an image after the concealment processing in which the concealment processing image is synthesized with each concealment area in the captured image is generated.

In step S3, the smartphone 11 transmits the image after the concealment processing to the front-end server 12 of the e-commerce site. Moreover, the smartphone 11 also transmits, to the front-end server 12, user information including a user identification (ID) for identifying the user when using the e-commerce site, and the like.

In step S11, the front-end server 12 receives the image after the concealment processing and the user information transmitted from the smartphone 11 in step S3.

In step S12, the front-end server 12 transmits a 3D model creation request for requesting execution of 3D model creation to the back-end server 13 together with the image after the concealment processing and the user information.

In step S21, the back-end server 13 receives the image after the concealment processing, the user information, and the 3D model creation request transmitted from the front-end server 12 in step S12.

In step S22, the back-end server 13 creates a 3D model in response to the 3D model creation request. The 3D model is created by performing three-dimensional reconstruction using the group of images after the concealment processing.

For three-dimensional reconstruction, for example, structure-from motion (SFM) is used. SFM is a technique of calculating a correspondence relationship of feature points between a plurality of images, and restoring a position and a posture of the camera and three-dimensional information of the feature points on the basis of the correspondence relationship of the feature points. The 3D model created by the SFM is expressed as, for example, a polygon mesh that is a set of vertices, sides, and faces. Moreover, three-dimensional reconstruction more precise than the SFM may be performed on the basis of the information obtained by the SFM.

In step S23, the back-end server 13 stores the 3D model created in step S22 in the data server. In a dedicated database managed by the data server, the 3D model is registered together with the user information.

In step S24, the back-end server 13 transmits a 3D model creation end notification, which is a notification indicating that the creation of the 3D model has ended, to the front-end server 12.

In step S13, the front-end server 12 receives the 3D model creation end notification transmitted from the back-end server 13 in step S24.

In step S14, the front-end server 12 transmits, to the smartphone 11, a service start notification which is a notification indicating that provision of the service using the 3D model is started.

In step S4, the smartphone 11 receives the service start notification transmitted from the front-end server 12 in step S14. Then, the smartphone 11 presents to the user that the provision of the service using the 3D model has started in the e-commerce site.

As described above, in the image processing system 1 of FIG. 1, for example, it is possible to provide a service using the 3D model without transmitting an image in which privacy information appears.

<2. Configuration of Smartphone>

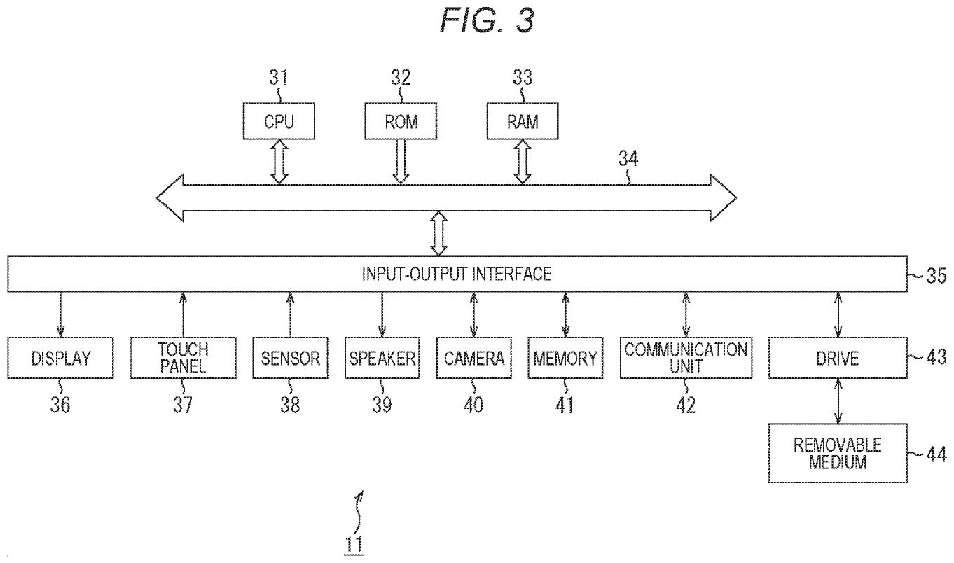

FIG. 3 is a block diagram illustrating a hardware configuration example of the smartphone 11.

A central processing unit (CPU) 31, a read only memory (ROM) 32, and a random access memory (RAM) 33 are mutually connected by a bus 34.

An input-output interface 35 is further connected to the bus 34. A display 36, a touch panel 37, a sensor 38, a speaker 39, a camera 40, a memory 41, a communication unit 42, and a drive 43 are connected to the input-output interface 35.

The display 36 includes, for example, a liquid crystal display (LCD), an organic electro-luminescence (EL) display, or the like. For example, as described above, the display 36 displays information indicating that the provision of the service using the 3D model has started in the e-commerce site.

The touch panel 37 detects a user's operation on a surface of the display 36 and outputs information indicating content of the user's operation.

The sensor 38 includes, for example, a gyro sensor, an acceleration sensor, and the like. The sensor 38 detects angular velocity, acceleration, and the like of the smartphone 11, and outputs observation data indicating a detection result.

The speaker 39 outputs various sounds such as a sound presenting that the provision of the service using the 3D model has started in the e-commerce site.

The camera 40 includes, for example, a complementary metal oxide semiconductor (CMOS) image sensor. Image-capturing is performed according to a user's operation, and image data is output.

The memory 41 includes, for example, a nonvolatile memory. The memory 41 stores various data necessary for the CPU 31 to execute the program.

The communication unit 42 is, for example, an interface for wireless communication. The communication unit 42 communicates with an external device such as the front-end server 12 connected via the network 14.

The drive 43 drives a removable medium 44 such as a memory card, writes data to the removable medium 44, and reads data stored in the removable medium 44.

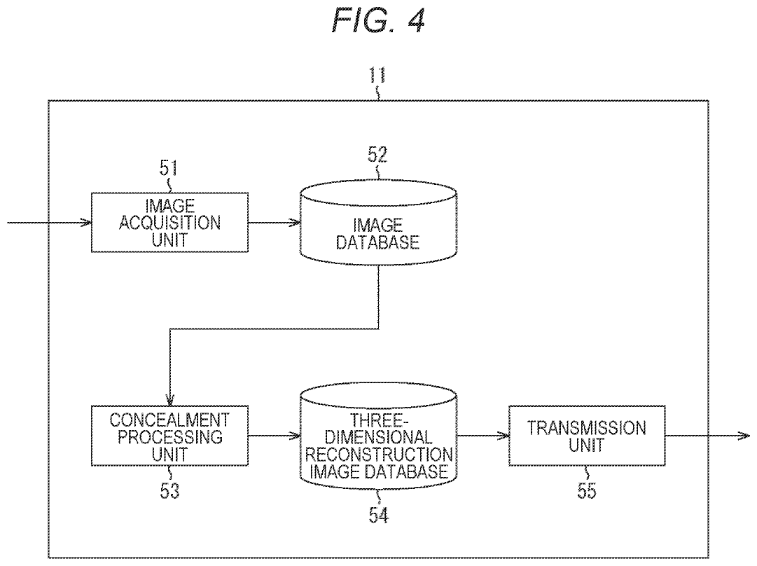

FIG. 4 is a block diagram illustrating a functional configuration example of the smartphone 11.

As illustrated in FIG. 4, in the smartphone 11, an image acquisition unit 51, an image database 52, a concealment processing unit 53, a three-dimensional reconstruction image database 54, and a transmission unit 55 are implemented. The image database 52 and the three-dimensional reconstruction image database 54 are implemented by, for example, the memory 41 in FIG. 3.

The image acquisition unit 51 controls the camera 40 to acquire a plurality of captured images obtained by capturing images of the room a plurality of times at different positions. The image acquisition unit 51 supplies the plurality of captured images to the image database 52 for storage therein.

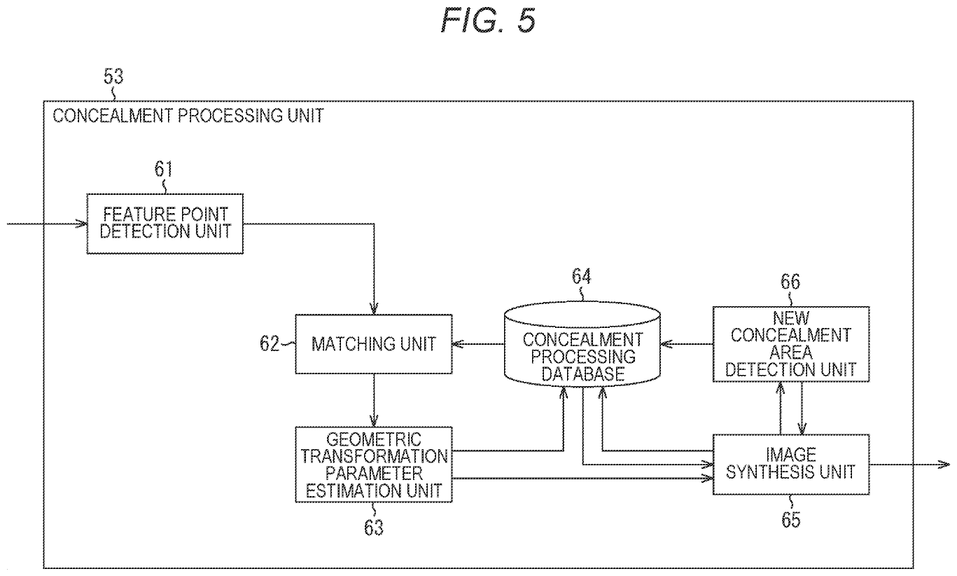

The concealment processing unit 53 sequentially acquires a plurality of captured images stored in the image database 52, for example, in the order of capturing, and performs the concealment processing on the concealment areas appearing in the captured images. The concealment processing unit 53 supplies the image after the concealment processing obtained as a result of the concealment processing to the three-dimensional reconstruction image database 54 for storage therein. Note that a detailed configuration of the concealment processing unit 53 will be described later with reference to FIG. 5.

The transmission unit 55 acquires the image after the concealment processing stored in the three-dimensional reconstruction image database 54, and transmits the image after the concealment processing to the front-end server 12 together with the user information.

For example, the user can perform an operation such as capturing an image of a room according to a guide or the like presented by an application installed in the smartphone 11 having the above configuration. Then, the smartphone 11 can perform the concealment processing on the plurality of captured images acquired according to the operation of the user, and transmit the image after the concealment processing in which the privacy information is concealed to the front-end server 12.

FIG. 5 is a block diagram illustrating a configuration example of the concealment processing unit 53.

As illustrated in FIG. 5, the concealment processing unit 53 includes a feature point detection unit 61, a matching unit 62, a geometric transformation parameter estimation unit 63, a concealment processing database 64, an image synthesis unit 65, and a new concealment area detection unit 66. The concealment processing database 64 is implemented by the memory 41 in FIG. 3, for example.

The feature point detection unit 61 acquires the captured images stored in the image database 52, and detects a feature point representing a point to be a feature in the captured image for each captured image.

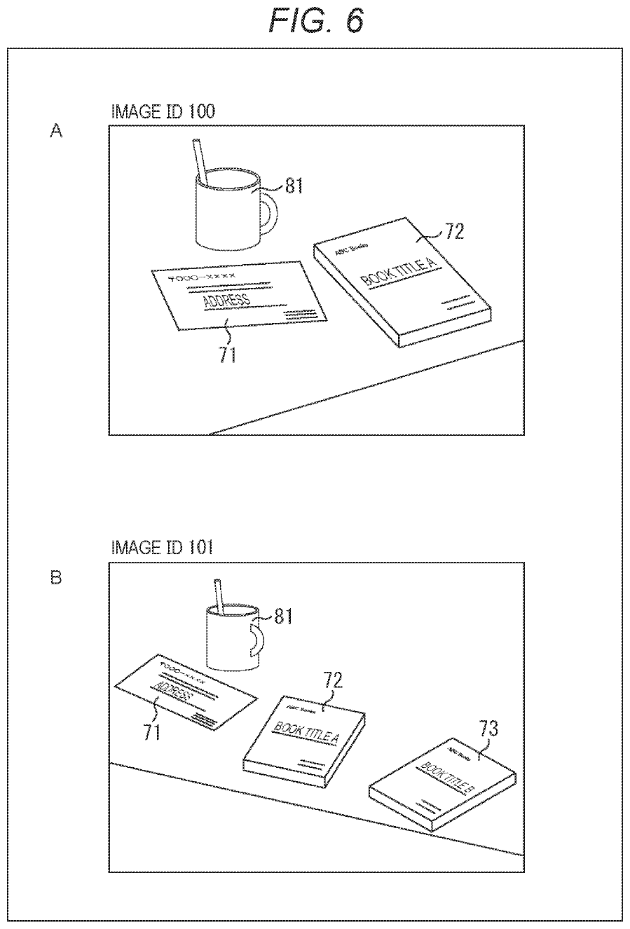

FIG. 6 is a diagram illustrating examples of captured images.

Captured images as illustrated in A and B of FIG. 6 in which a state of a room appears are used as an image as the processing target in the feature point detection unit 61. The captured image illustrated in A of FIG. 6 is an image stored in the image database 52 as an image with an image ID of 100. Furthermore, the captured image in B of FIG. 6 is an image stored in the image database 52 with an image ID of 101. The image ID is an ID given to identify each captured image.

In the captured image in A of FIG. 6, a letter 71, a book 72, and a cup 81 placed on a desk appear. The cup 81 appears at an upper left position in the captured image, and the letter 71 and the book 72 appear side by side near the center in the captured image. On the letter 71, an address and the like are described by text. Furthermore, in the book 72, a book name, a publishing company, and the like are described by text.

On the other hand, the captured image in B of FIG. 6 is a captured image obtained by image-capturing the desk in the captured image in A of FIG. 6 from a position different from the capturing position of the captured image in A of FIG. 6.

In the captured image in B of FIG. 6, the letter 71, the book 72, a book 73, and the cup 81 appear. In the captured image in B of FIG. 6, the letter 71, the book 72, and the cup 81 appear at positions different from the positions in the captured image in A of FIG. 6. Note that, in the book 73 appearing on the right side of the book 72, a book name, a publishing company, and the like are described by text, similarly to the book 72.

The concealment processing unit 53 performs a series of processing on each captured image in which such a state of the room appears.

Returning to the description of FIG. 5, the feature point detection unit 61 detects a feature point in the captured image as the processing target, and calculates a feature amount obtained by quantifying what feature is present at each feature point. Note that the unit of pixel for detecting the feature point and the feature amount can be arbitrarily set. The feature point detection unit 61 supplies information indicating the feature amount of each feature point in the captured image to the matching unit 62 together with the captured image.

The matching unit 62 acquires information regarding the concealment area that has been detected from the concealment processing database 64. The concealment processing database 64 stores information regarding the concealment area that has been detected. The information regarding the concealment area that has been detected includes feature points included in the concealment area that has been detected and respective feature amounts of the feature points.

The matching unit 62 performs matching between the feature points of the captured image supplied from the feature point detection unit 61 and the feature points included in the concealment area that has been detected acquired from the concealment processing database 64 on the basis of the respective feature amounts.

For example, it is assumed that the concealment processing has already been performed on the captured image with the image ID 100 described with reference to A of FIG. 6, and a feature point of the captured image with the image ID 101 described with reference to B of FIG. 6 is supplied from the feature point detection unit 61 to the matching unit 62 as the next processing target. In this case, the matching unit 62 selects one of the plurality of concealment areas included in the captured image with the image ID 100, acquires the feature amount of each feature point included in the selected concealment area, and performs matching with the feature amount of the feature point of the captured image with the image ID 101 for each feature point.

Then, on the basis of the matching result, the matching unit 62 searches for a concealment area corresponding to the concealment area that has been detected, that is, a concealment area in which an area common to the concealment area that has been detected is to be concealed in the captured image as the processing target. For example, the search for the concealment area is performed on the basis of the number of feature points for which matching is established. Note that by using a RANSAC algorithm together, accuracy of matching can be improved.

Thereafter, the matching unit 62 supplies the corresponding feature point information and the captured image to the geometric transformation parameter estimation unit 63. The corresponding feature point information includes information indicating the concealment area found from the captured image. Furthermore, the corresponding feature point information includes information indicating a relationship between a feature point included in the concealment area found from the captured image and a feature point in the concealment area that has been detected.

As described above, the matching unit 62 can search the captured image as the processing target for the concealment area in which the area common to the concealment area that has been detected is to be concealed in the captured image after the concealment processing on which the concealment processing for concealing the concealment area has already been performed.

The geometric transformation parameter estimation unit 63 estimates a geometric transformation parameter used for deformation of the concealment processing image on the basis of the corresponding feature point information supplied from the matching unit 62. The geometric transformation parameter is an affine transformation parameter, a homography transformation parameter, or the like. For example, the geometric transformation parameter is estimated by estimating a parameter corresponding to the shape of the found concealment area.

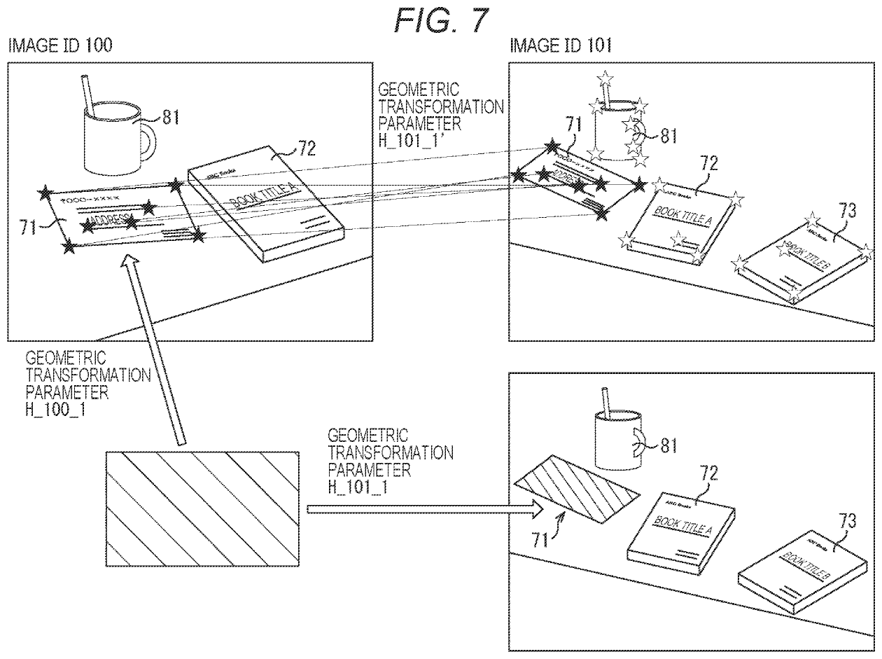

FIG. 7 is a diagram illustrating an example of a method of estimating the geometric transformation parameter.

The captured image illustrated in the upper left of FIG. 7 is a captured image with the image ID 100 in which the concealment area has already been detected. A black star on the captured image with the image ID 100 represents a feature point included in the concealment area that has been detected. In the example of FIG. 7, in the captured image with the image ID 100, the entire area of the letter 71 is the concealment area that has been detected.

The captured image illustrated in the upper right of FIG. 7 is the captured image with the image ID 101 used for the matching of the feature points by the matching unit 62. A black star and a white star on the captured image with the image ID 101 represent feature points detected by the feature point detection unit 61. In the example of FIG. 7, particularly, a black star represents a feature point matched with a feature point included in the concealment area that has been detected in the image ID 100 as illustrated by connecting with straight lines.

As described above, in the example of FIG. 7, the entire area of the letter 71 appearing in the captured image with the image ID 101 is found as the concealment area corresponding to the entire area of the letter 71 appearing as the concealment area in the captured image with the image ID 100 on the basis of the matching result.

The geometric transformation parameter estimation unit 63 estimates a geometric transformation parameter H_101_1′ for transforming each pixel position forming the letter 71 appearing in the captured image with the image ID 100 into each pixel position on the letter 71 appearing in the captured image with the image ID 101, on the basis of the correspondence relationship between the feature points on the area of the letter 71 appearing in the captured image with the image ID 100 and the feature points on the area of the letter 71 appearing in the captured image with the image ID 101. The geometric transformation parameter is estimated by, for example, RANSAC including parameter estimation.

A geometric transformation parameter H_100_1 illustrated on the left side of FIG. 7 is a geometric transformation parameter corresponding to the shape of the area of the letter 71, which is the concealment area that has been detected, appearing in the captured image with the image ID 100, and is stored in the concealment processing database 64. Furthermore, the geometric transformation parameter H_100_1 is included in the information regarding the concealment area that has been detected, is acquired by the matching unit 62 from the concealment processing database 64, and is supplied to the geometric transformation parameter estimation unit 63. Note that a horizontally long rectangle hatched at a lower left in FIG. 7 represents the concealment processing image. That is, the geometric transformation parameter H_100_1 is used to transform the horizontally long rectangular concealment processing image into the shape of the letter 71 appearing in the captured image with the image ID 100.

The geometric transformation parameter estimation unit 63 synthesizes the geometric transformation parameter H_100_1 and the geometric transformation parameter H_101_1′ to estimate a geometric transformation parameter H_101_1 corresponding to the shape of the letter 71 appearing in the captured image with the image ID 101. Therefore, in order to conceal the letter 71 common to the concealment area of the captured image with the image ID 100 by the captured image with the image ID 101, the geometric transformation parameter H_101_1 is used to transform the horizontally long rectangular concealment processing image into the shape of the letter 71 appearing in the captured image with the image ID 101.

Furthermore, the geometric transformation parameter is also used to create a concealment area mask. The concealment area mask is mask data for representing the concealment area. The concealment area mask is used when the concealment processing image is synthesized with the captured image. The geometric transformation parameter estimation unit 63 performs the geometric transformation on the concealment area mask of the concealment area that has been detected by using the geometric transformation parameter H_101_1′, and creates the concealment area mask corresponding to the shape of the letter 71 appearing in the captured image with the image ID 101.

Returning to the description of FIG. 5, the geometric transformation parameter estimation unit 63 supplies the captured image as the processing target and the information regarding the concealment area in association with each other to the concealment processing database 64 for storage therein. The information regarding the concealment area includes the feature point of the concealment area, the feature amount of the feature point, the geometric transformation parameter of the concealment area, and the concealment area mask of the concealment area.

Note that in a case where a plurality of different geometric transformation parameters is estimated on the basis of the corresponding feature point information, the plurality of estimated geometric transformation parameters may be stored in association with different concealment areas. The captured image as the processing target is supplied from the geometric transformation parameter estimation unit 63 to the image synthesis unit 65.

The processing performed by the matching unit 62 and the processing performed by the geometric transformation parameter estimation unit 63 are performed on all the concealment areas that have been detected.

The concealment processing database 64 stores the information supplied from the geometric transformation parameter estimation unit 63. Furthermore, a plurality of concealment processing images is stored in advance in the concealment processing database 64.

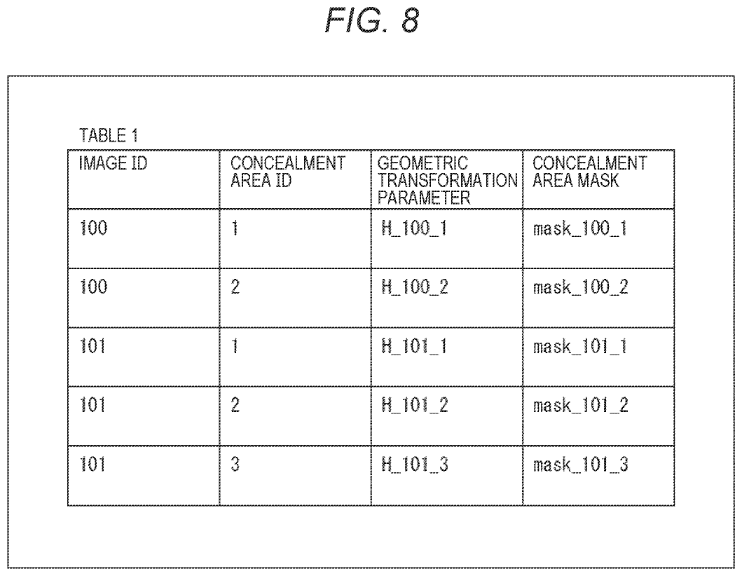

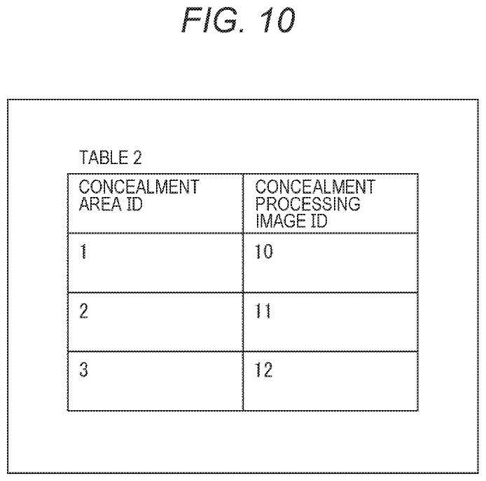

Information managed by the concealment processing database 64 will be described with reference to FIGS. 8 to 10. For example, the concealment processing database 64 stores a table 1 of FIG. 8 and a table 2 of FIG. 10.

FIG. 8 is a diagram illustrating an example of the table 1 stored in the concealment processing database 64.

In the table 1 of FIG. 8, “image ID”, “concealment area ID”, “geometric transformation parameter”, and “concealment area mask” are associated with each other. The concealment area ID is an ID given to identify each concealment area.

For example, the concealment area ID 1 given to the area of the letter 71, the geometric transformation parameter H_100_1, and a concealment area mask mask_100_1 are associated with the image ID 100.

Therefore, a mask is applied to the concealment area with the concealment area ID 1 of the image ID 100 using the concealment area mask mask_100_1.

Furthermore, the concealment area ID 2 given to the area of the cover of the book 72, a geometric transformation parameter H_100_2, and a concealment area mask mask_100_2 are also associated with the image ID 100. Therefore, a mask is applied to the concealment area with the concealment area ID 2 of the image ID 100 using the concealment area mask mask_100_2.

Then, similarly, the concealment area ID, the geometric transformation parameter, and the concealment area mask are associated with the image ID 101 for each concealment area ID. Therefore, a mask is applied to each of the concealment areas with the image ID 101 using the concealment area mask associated with the concealment area ID.

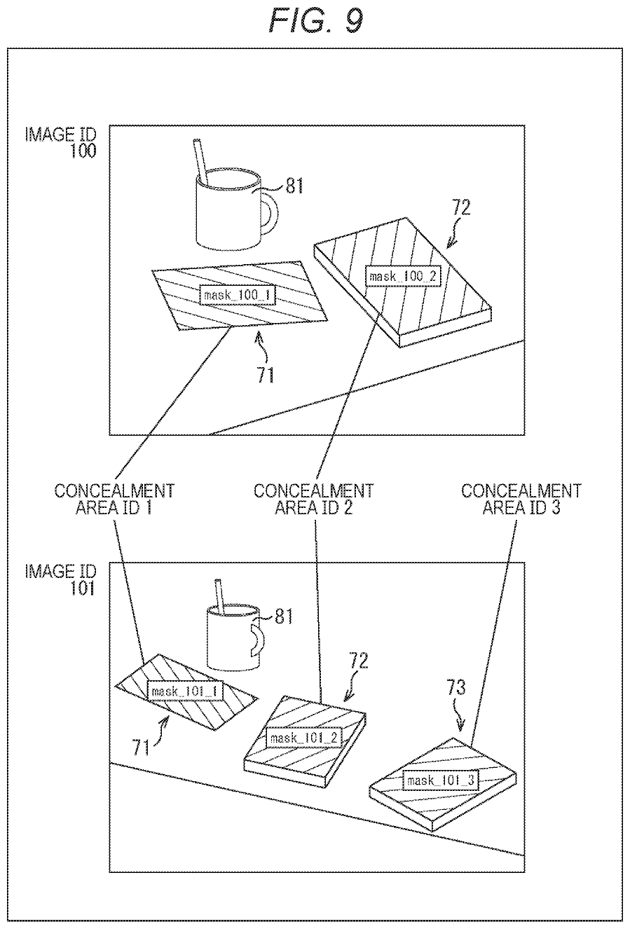

FIG. 9 is a diagram illustrating examples of concealment areas masked using concealment area masks.

In the example of FIG. 9, a hatched area represents a concealment area masked using a concealment area mask.

In the captured image with the image ID 100 illustrated in an upper part of FIG. 9, the entire area of the letter 71 with the concealment area ID 1 is masked using the concealment area mask mask_100_1. Furthermore, the entire area of the cover of the book 72 with the concealment area ID 2 is masked using the concealment area mask mask_100_2.

In the captured image with the image ID 101 illustrated in a lower part of FIG. 9, as in the captured image with the image ID 100, the entire area of the letter 71 with the concealment area ID 1 and the entire area of the cover of the book 72 with the concealment area ID 2 are masked using the concealment area masks mask mask_101_1 and mask_101_2 associated with the respective concealment area IDs. Furthermore, the entire area of the cover of the book 73 with the concealment area ID 3 is masked using a concealment area mask mask_101_3.

The concealment processing image is synthesized with the masked concealment area. A table representing the correspondence relationship between the concealment areas and the concealment processing images is stored in the concealment processing database 64.

FIG. 10 is a diagram illustrating an example of the table 2 stored in the concealment processing database 64.

In the table 2 of FIG. 10, “concealment area ID” and “concealment processing image ID” are associated with each other. The concealment processing image ID is an ID given to identify each concealment processing image.

For example, the concealment processing image ID 10 is associated with the concealment area ID 1. In this manner, the concealment area ID and the concealment processing image ID are associated in a one-to-one relationship. Therefore, the same concealment processing image is synthesized with the concealment areas with the same concealment area IDs. Furthermore, different concealment processing images are synthesized with the concealment areas with different concealment processing image IDs.

Note that the feature point included in the concealment area and the feature amount of each feature point are stored in a table, a column, or the like that is not illustrated for feature point data and feature amount data provided in the concealment processing database 64.

Returning to the description of FIG. 5, the image synthesis unit 65 acquires, from the concealment processing database 64, information regarding the concealment area associated with the image ID of the captured image supplied from the geometric transformation parameter estimation unit 63. Specifically, the geometric transformation parameter, the concealment area mask, and the concealment processing image corresponding to the concealment area included in the captured image are acquired.

The image synthesis unit 65 masks the concealment area included in the captured image supplied from the geometric transformation parameter estimation unit 63 using the concealment area mask. Furthermore, the image synthesis unit 65 performs geometric transformation on the concealment processing image by using the geometric transformation parameter, and synthesizes the concealment processing image with the captured image. Note that the concealment processing image that has not been subjected to the geometric transformation may be synthesized. The image synthesis unit 65 supplies a synthesized image obtained by synthesizing the concealment processing image with the captured image to the new concealment area detection unit 66.

Furthermore, the image synthesis unit 65 synthesizes the concealment processing image with the synthesized image using the geometric transformation parameter and the concealment area mask supplied from the new concealment area detection unit 66, and generates an image after the concealment processing. The new concealment area detection unit 66 detects a new concealment area (a concealment area not stored in the concealment processing database 64) included in the synthesized image as the processing target. Information regarding the new concealment area is supplied from the new concealment area detection unit 66 to the image synthesis unit 65.

Specifically, the image synthesis unit 65 acquires the concealment processing image that is not associated with the concealment area ID in the concealment processing database 64 from the concealment processing database 64.

The image synthesis unit 65 masks the new concealment area included in the synthesized image as the processing target using the concealment area mask supplied from the new concealment area detection unit 66. Furthermore, the image synthesis unit 65 performs the geometric transformation on the concealment processing image using the geometric transformation parameter supplied from the new concealment area detection unit 66, and synthesizes the concealment processing image with the synthesized image. Note that the concealment processing image that has not been subjected to the geometric transformation may be synthesized.

The image synthesis unit 65 supplies the concealment processing image synthesized with the synthesized image in association with the information regarding the new concealment area to the concealment processing database 64 for storage therein. The concealment processing image and the information regarding the new concealment area are associated with the same image ID as the captured image that is the source of the synthesized image. The information regarding the new concealment area includes the geometric transformation parameter and the concealment area mask. Furthermore, the image synthesis unit 65 supplies the image after the concealment processing to the three-dimensional reconstruction image database 54 (FIG. 4) for storage therein.

The new concealment area detection unit 66 detects the new concealment area included in the synthesized image supplied from the image synthesis unit 65. The new concealment area detection unit 66 detects, for example, a text area which is an area including a text describing privacy information or an area to which a semantic label is given as privacy information. Note that the detection of the new concealment area may be performed using a prediction model obtained by machine learning. The new concealment area detection unit 66 generates the information regarding the new concealment area and supplies the information to the image synthesis unit 65.

Furthermore, the new concealment area detection unit 66 supplies the feature point included in the detected new concealment area and the feature amount of each feature point to the concealment processing database 64 for storage therein. The stored feature point and the feature amount of each feature point are used in the matching of the feature points performed by the matching unit 62.

As described above, the concealment area of the captured image is detected, and the concealment processing image is synthesized with the detected concealment area.

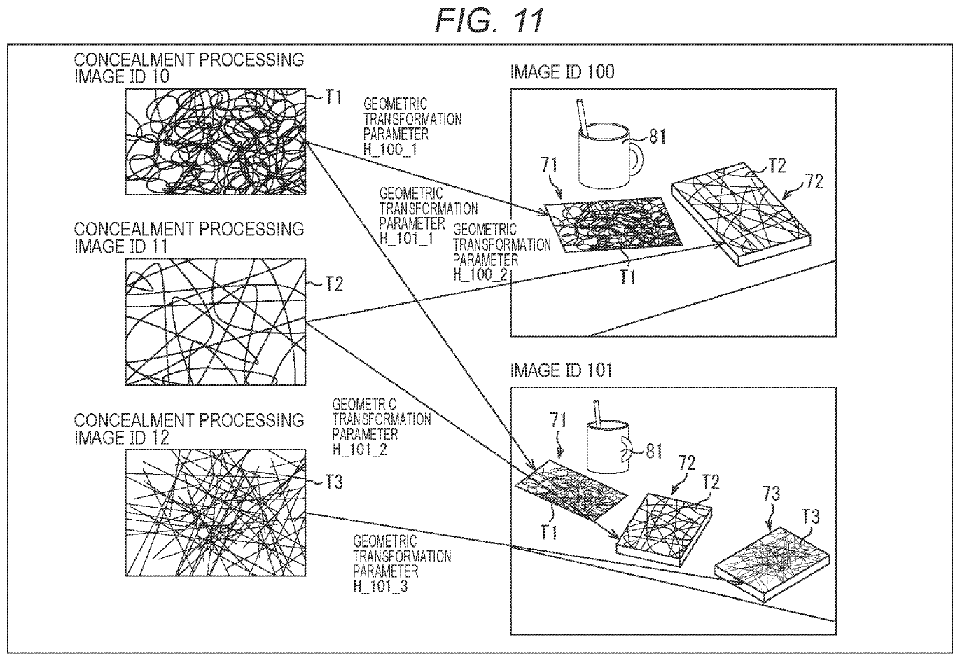

FIG. 11 is a diagram illustrating an example of synthesis of the concealment processing image.

Concealment processing images T1 to T3 illustrated on a left side of FIG. 11 are images to which concealment processing image IDs 10 to 12 are given, respectively. The concealment processing images T1 to T3 are desirably images formed by unique textures or a part of the images. For example, the unique texture refers to a texture that includes many textures in which the same texture pattern does not repeatedly appear in one concealment processing image, and a texture pattern common to other concealment processing images does not appear. That is, the unique texture is formed by a texture generated so as to eliminate repeated appearance of the same texture pattern in one concealment processing image, and to avoid existence of a texture pattern common to other concealment processing images.

According to the table 2 in FIG. 10, the concealment processing image T1 is synthesized on the area of the letter 71, which is the concealment area with the concealment area ID 1. The concealment processing image T1 is subjected to the geometric transformation using the geometric transformation parameter H_100_1, and the concealment processing image T1 after the geometric transformation is synthesized with the area of the letter 71 appearing in the captured image with the image ID 100.

Furthermore, the concealment processing image T1 is subjected to the geometric transformation using the geometric transformation parameter H_101_1, and the concealment processing image T1 after the geometric transformation is synthesized with the area of the letter 71 captured in the captured image with the image ID 101.

The concealment processing image T2 is subjected to the geometric transformation using each of the geometric transformation parameters H_100_2 and H_101_2, and the concealment processing image T2 after the geometric transformation is synthesized with the area of the cover of the book 72 appearing in each of the captured images with the image ID 100 and the image ID 101.

The concealment processing image T3 is subjected to the geometric transformation using a geometric transformation parameter H_101_3, and the concealment processing image T3 after the geometric transformation is synthesized with the area of the book 73 appearing in the captured image with the image ID 101.

Note that the area of the cover of the book 73 included in the captured image with the image ID 101 is an area detected as a new concealment area. The geometric transformation parameter H_101_3 used for the geometric transformation of the concealment processing image T3 synthesized with the cover area of the book 73 is stored in the concealment processing database 64 in association with the concealment processing image ID 12 after the concealment processing image is synthesized with the synthesized image.

<3. Operation of Smartphone>

Next, an operation of the smartphone 11 having the configuration as above will be described.

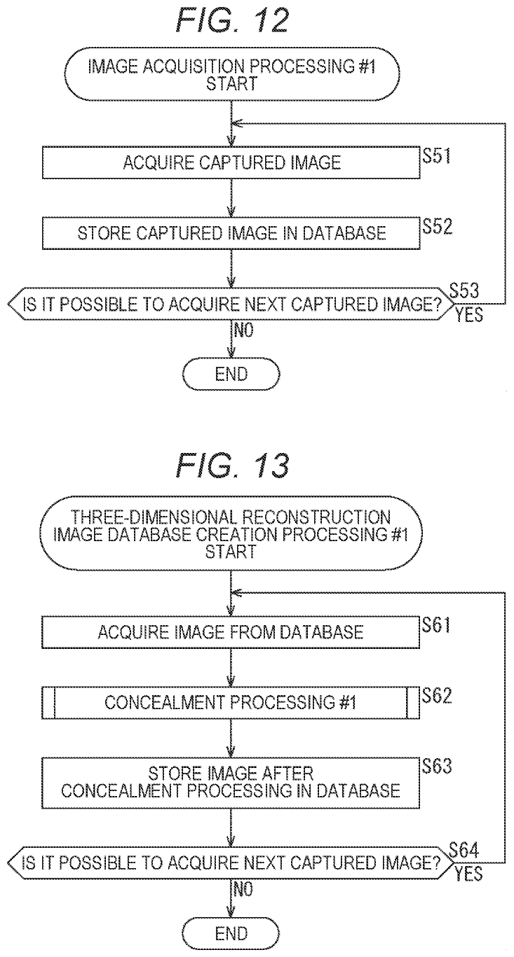

First, image acquisition processing #1 of the smartphone 11 will be described with reference to a flowchart of FIG. 12.

In step S51, the image acquisition unit 51 controls the camera 40 to acquire a captured image.

In step S52, the image acquisition unit 51 supplies the captured image acquired in step S51 to the image database 52 for storage therein.

In step S53, the image acquisition unit 51 determines whether or not the next captured image can be acquired. For example, the image acquisition unit 51 determines that the next captured image can be acquired until the user performs an operation to end the image-capturing for creating the 3D model.

In a case where it is determined in step S53 that the next captured image can be acquired, the processing returns to step S51, and similar processing is repeatedly performed thereafter.

On the other hand, in a case where it is determined in step S53 that the next captured image cannot be acquired, the processing is terminated.

Next, three-dimensional reconstruction image database creation processing #1 of the smartphone 11 will be described with reference to a flowchart of FIG. 13. The three-dimensional reconstruction image database creation processing #1 is processing in which the image after the concealment processing obtained as a result of synthesizing the concealment processing image with the concealment area captured in the captured image is stored in the three-dimensional reconstruction image database 54.

In step S61, the concealment processing unit 53 acquires the captured image from the image database 52.

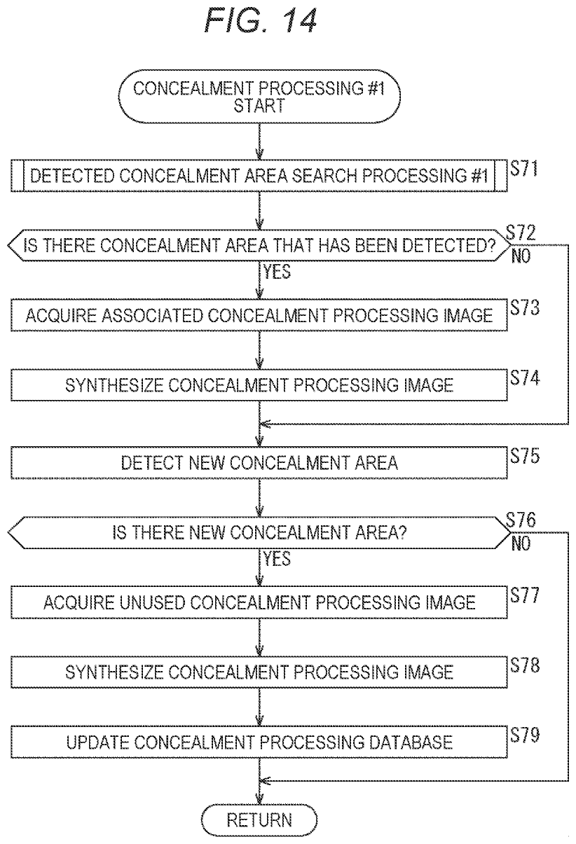

In step S62, the concealment processing unit 53 performs concealment processing #1. By the concealment processing #1, the concealment area is detected from the captured image as the processing target, and an image after the concealment processing is generated. Note that the concealment processing #1 will be described later with reference to a flowchart of FIG. 14.

In step S63, the concealment processing unit 53 supplies the image after the concealment processing generated in the concealment processing #1 in step S62 to the three-dimensional reconstruction image database 54 for storage therein.

In step S64, the concealment processing unit 53 determines whether or not the next captured image can be acquired from the image database 52. For example, in a case where there is a captured image that has not yet been set as the processing target among all the captured images captured for creating the 3D model, the concealment processing unit 53 determines that the next captured image can be acquired from the image database 52.

In a case where it is determined in step S64 that the next captured image can be acquired from the image database 52, the processing returns to step S61, and similar processing is repeatedly performed thereafter.

On the other hand, in a case where it is determined in step S64 that the next captured image cannot be acquired from the image database 52, the processing is terminated.

The concealment processing #1 performed in step S62 of FIG. 13 will be described with reference to the flowchart of FIG. 14.

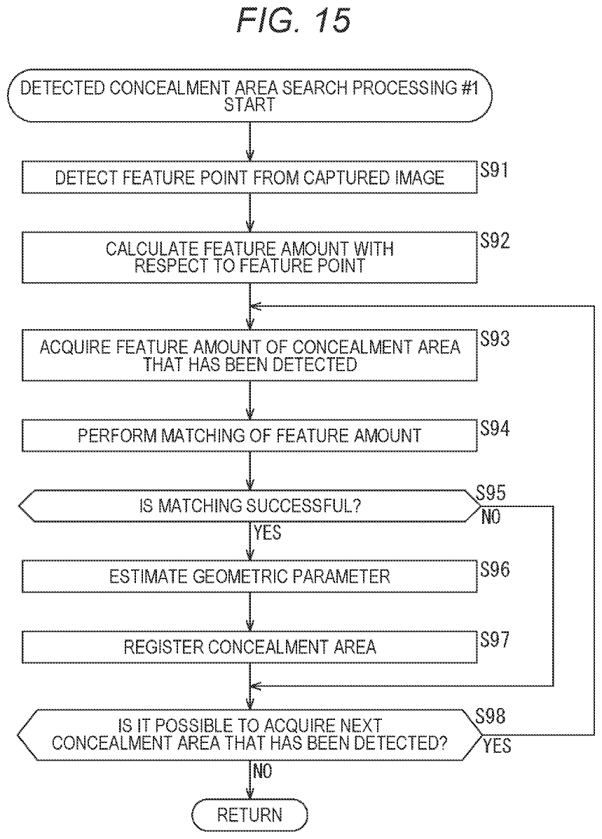

In step S71, the concealment processing unit 53 performs detected concealment area search processing #1. The concealment area corresponding to the concealment area that has been detected included in the captured image as the processing target is found by the detected concealment area search processing #1. Note that the detected concealment area search processing #1 will be described later with reference to a flowchart of FIG. 15.

In step S72, the image synthesis unit 65 determines whether or not the concealment area corresponding to the concealment area that has been detected is in the captured image as the processing target on the basis of a result of the detected concealment area search processing #1 in step S71.

In a case where it is determined in step S72 that the concealment area corresponding to the concealment area that has been detected is in the captured image as the processing target, the processing proceeds to step S73, and the image synthesis unit 65 acquires the concealment processing image associated with the found concealment area from the concealment processing database 64 together with the information regarding the concealment area. As described above, the information regarding the concealment area includes the concealment area mask, the geometric transformation parameter, and the like.

In step S74, the image synthesis unit 65 masks the concealment area included in the captured image using the concealment area mask, and performs the geometric transformation on the concealment processing image using the geometric transformation parameter. Moreover, the image synthesis unit 65 synthesizes the concealment processing image subjected to the geometric transformation with the captured image to generate a synthesized image. The image synthesis unit 65 supplies the synthesized image to the new concealment area detection unit 66, and the processing proceeds to step S75.

On the other hand, in a case where it is determined in step S72 that the concealment area corresponding to the concealment area that has been detected is not in the captured image as the processing target, processing of steps S73 and S74 is skipped, and the processing proceeds to step S75.

In step S75, the new concealment area detection unit 66 detects a new concealment area included in the synthesized image. The new concealment area detection unit 66 generates the information regarding the new concealment area and supplies the information to the image synthesis unit 65. Note that in a case where the processing of steps S73 and S74 is skipped, similar processing is performed on the captured image instead of the synthesized image. Furthermore, the same applies to the following processing.

In step S76, the image synthesis unit 65 determines whether or not the new concealment area exists in the synthesized image according to the detection result by the new concealment area detection unit 66 in step S75.

In a case where it is determined in step S76 that there is a new concealment area, the processing proceeds to step S77, and the image synthesis unit 65 acquires an unused concealment processing image from the concealment processing database 64. The unused concealment processing image is concealment processing image that is not associated with the concealment area ID in the concealment processing database 64.

In step S78, the image synthesis unit 65 masks the synthesized image using the concealment area mask supplied from the new concealment area detection unit 66, and performs the geometric transformation on the acquired concealment processing image using the geometric transformation parameter. Then, the image synthesis unit 65 synthesizes the concealment processing image subjected to the geometric transformation with the synthesized image to generate an image after the concealment processing.

In step S79, the image synthesis unit 65 supplies the concealment processing image synthesized with the synthesized image in association with the information regarding the new concealment area to the concealment processing database 64 for storage therein. Thereafter, the processing returns to step S62 in FIG. 13, and the subsequent processing is performed.

On the other hand, in a case where it is determined in step S76 that there is no new concealment area, processing of steps S77 to S79 is skipped, the processing returns to step S62 in FIG. 13, and the subsequent processing is performed. Note that, in this case, similar processing is performed with the synthesized image generated in step S74 as the image after the concealment processing.

The detected concealment area search processing #1 performed in step S71 of FIG. 14 will be described with reference to the flowchart of FIG. 15.

In step S91, the feature point detection unit 61 detects a feature point from the captured image as the processing target.

In step S92, the feature point detection unit 61 calculates the feature amount of each feature point detected in step S91. Then, the feature point detection unit 61 supplies information indicating the feature amount of each feature point in the captured image and the captured image to the matching unit 62.

In step S93, the matching unit 62 acquires the feature point included in the concealment area that has been detected and the feature amount of each feature point from the concealment processing database 64.

In step S94, the matching unit 62 performs matching between the feature point of the captured image and the feature point included in the concealment area that has been detected on the basis of the respective feature amounts.

In step S95, the matching unit 62 determines whether or not the matching of the feature points is successful.

In a case where it is determined in step S95 that the matching of the feature points is successful, the processing proceeds to step S96. For example, in a case where the concealment area corresponding to the concealment area that has been detected acquired from the concealment processing database 64 is in the captured image as the processing target, the concealment area is found by the matching unit 62, and it is determined that the matching of the feature points is successful.

In step S96, the matching unit 62 supplies the corresponding feature point information and the captured image to the geometric transformation parameter estimation unit 63. In response to this, the geometric transformation parameter estimation unit 63 estimates a geometric transformation parameter corresponding to the shape of the concealment area found by the matching unit 62 on the basis of the corresponding feature point information. Then, the geometric transformation parameter estimation unit 63 creates the concealment area mask using the estimated geometric transformation parameter.

In step S97, the geometric transformation parameter estimation unit 63 supplies the captured image as the processing target and the information regarding the concealment area in association with each other to the concealment processing database 64 for storage therein. Thereafter, the processing proceeds to step S98.

On the other hand, in a case where it is determined in step S95 that the matching of the feature points has failed, processing of steps S96 and S97 is skipped, and the processing proceeds to step S98. For example, in a case where the concealment area corresponding to the concealment area that has been detected acquired from the concealment processing database 64 is not present in the captured image as the processing target, it is determined that the matching of the feature points has failed.

In step S98, the matching unit 62 determines whether or not the next concealment area that has been detected can be acquired. For example, in a case where there is a concealment area for which matching has not been performed for all the concealment areas detected from the captured image for which the concealment processing has already been performed, the matching unit 62 determines that the next concealment area that has been detected can be acquired.

In a case where it is determined in step S98 that the next concealment area that has been detected can be acquired, the processing returns to step S93, and similar processing is repeatedly performed thereafter.

On the other hand, in a case where it is determined in step S98 that the next concealment area that has been detected cannot be acquired, that is, in a case where matching is performed for all the concealment areas that have been detected, the geometric transformation parameter estimation unit 63 supplies the captured image to the image synthesis unit 65. Thereafter, the processing returns to step S71 in FIG. 14, and the subsequent processing is performed.

With the above processing, it is possible to generate an image after the concealment processing in which privacy information in a captured image is concealed without losing information such as resolution and texture of the captured image used for 3D model creation.

That is, by synthesizing the concealment processing image including the unique texture with the concealment area, it is possible to maintain the geometric relationship between the concealment areas that conceal the area common to the plurality of images after the concealment processing, and it is possible to accurately create the 3D model using the images after the concealment processing.

For example, in the techniques disclosed in Patent Documents 3 and 4 described above, image processing such as resolution reduction, filling, blurring, and mosaicking is performed, but in such image processing, texture and geometric information necessary for creating the 3D model are lost from the image. On the other hand, in the concealment processing of the present technology, the geometric relationship between the concealment areas that conceal the area common to the plurality of images after the concealment processing is maintained, and it is possible to avoid loss of texture and geometric information necessary for creating the 3D model from the image.

Furthermore, it is possible to generate an image after the concealment processing in which privacy information in the captured image is concealed without increasing a burden on the user.

For example, in the technology disclosed in Patent Document 5 described above, in order to synthesize a preset image with respect to an area designated by a user, it is necessary to designate a mask area one by one with respect to a group of a large number of images or appropriately designate an image to be synthesized, and a burden on the user is large. On the other hand, in the concealment processing of the present technology, it is not necessary for the user to perform the designation, and it is possible to avoid an increase in the burden on the user.

<4. Example Using Camera Posture>

A camera posture estimated at the time of acquiring a captured image may be used for searching for the concealment area corresponding to the concealment area that has been detected. The camera posture is represented by parameters of six degrees of freedom representing the position and rotation of the camera that has performed image-capturing.

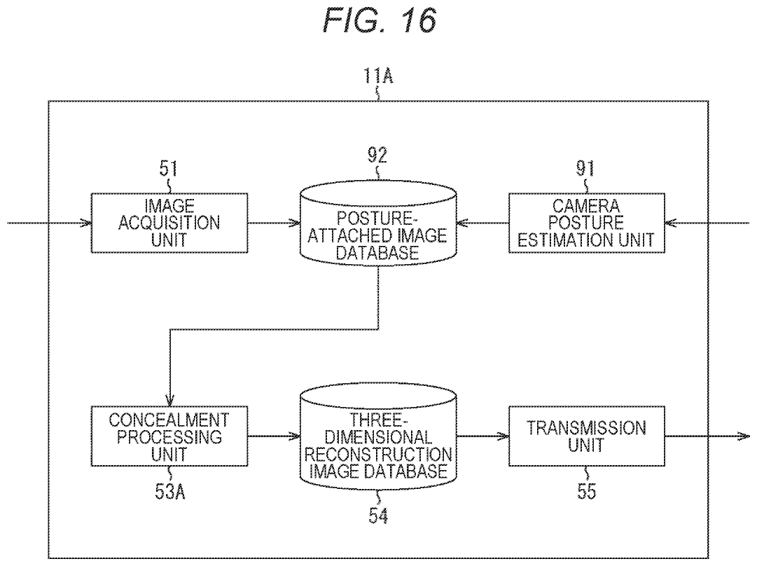

FIG. 16 is a block diagram illustrating a configuration example of a smartphone 11A.

In the smartphone 11A illustrated in FIG. 16, the same reference numerals are given to components common to the components of the smartphone 11 illustrated in FIG. 4. Duplicate descriptions will be omitted as appropriate.

That is, the smartphone 11A is common to the smartphone 11A in FIG. 4 in including the image acquisition unit 51, the three-dimensional reconstruction image database 54, and the transmission unit 55.

On the other hand, the smartphone 11A is different from the smartphone 11 in FIG. 4 in including a camera posture estimation unit 91, a posture-attached image database 92, and a concealment processing unit 53A. The camera posture estimation unit 91 is supplied with a plurality of captured images which are the same as the captured images supplied to the image acquisition unit 51.

The camera posture estimation unit 91 estimates the camera posture at the time of capturing each captured image on the basis of the plurality of supplied captured images. For example, visual simultaneous localization and mapping (SLAM) is used to estimate the camera posture.

In order to improve accuracy of estimation of the camera posture, observation data of the sensor 38 including a gyro sensor, an acceleration sensor, and the like may be supplied to the camera posture estimation unit 91. In this case, the camera posture estimation unit 91 estimates the camera posture of each captured image on the basis of the observation data and the captured image.

The camera posture estimation unit 91 supplies information indicating the estimated camera posture to the posture-attached image database 92 for storage therein in association with the captured image. The posture-attached image database 92 stores the captured image acquired by the image acquisition unit 51.

Note that the concealment processing unit 53A acquires the captured image stored in the posture-attached image database 92 and the information indicating the camera posture, and performs the concealment processing on the concealment area appearing in the captured image. The concealment processing unit 53A supplies the image after the concealment processing to the three-dimensional reconstruction image database 54 for storage therein.

In addition to the image after the concealment processing, the information indicating the camera posture at the time of capturing the captured image that is the source of the image after the concealment processing may be stored in the three-dimensional reconstruction image database 54. In this case, the transmission unit 55 transmits the information indicating the camera posture to the front-end server 12 together with the image after the concealment processing. For example, by using the camera posture as an initial value for performing the three-dimensional reconstruction in the back-end server 13, the processing of the three-dimensional reconstruction can be speeded up. Furthermore, accuracy of the three-dimensional reconstruction can be improved.

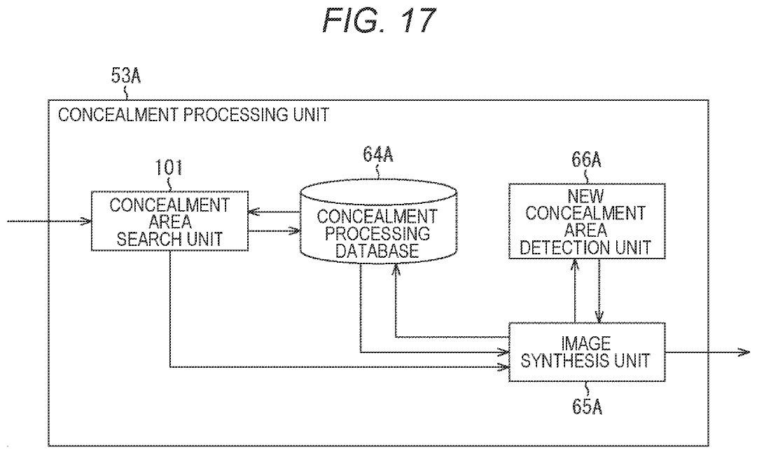

FIG. 17 is a block diagram illustrating a configuration example of the concealment processing unit 53A.

As illustrated in FIG. 17, the concealment processing unit 53A includes a concealment area search unit 101, a concealment processing database 64A, an image synthesis unit 65A, and a new concealment area detection unit 66A.

The concealment area search unit 101 acquires the captured image stored in the posture-attached image database 92 and the camera posture of the captured image. Furthermore, the concealment area search unit 101 acquires information regarding a concealment area that has been detected from the concealment processing database 64A. Here, the information regarding the concealment area that has been detected includes the information indicating the camera posture associated with the concealment area ID, a concealment area mask, and a plane parameter. The plane parameter is a parameter representing a plane in a three-dimensional space where the concealment area that has been detected exists.

Except that the plane parameters are stored instead of the geometric transformation parameters, information basically similar to the information stored in the concealment processing database 64 of FIG. 5 is stored in the concealment processing database 64A. Furthermore, the information indicating the camera posture of the captured image is stored in the concealment processing database 64A.

The concealment area search unit 101 searches for the concealment area in the captured image as the processing target corresponding to the concealment area that has been detected on the basis of the information regarding the concealment area that has been detected and the camera posture of the captured image as the processing target.

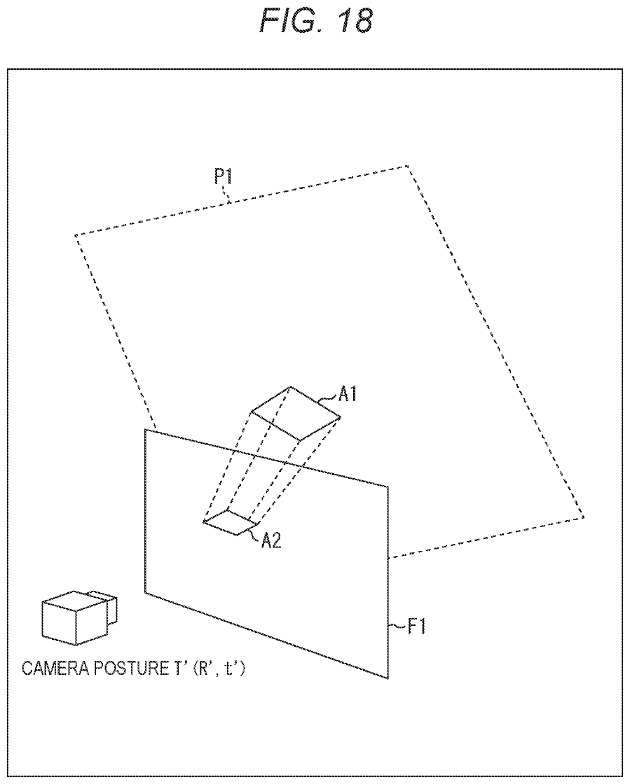

FIG. 18 is a diagram illustrating an example of a method of searching for a concealment area corresponding to the concealment area that has been detected using the camera posture.

For example, as illustrated in FIG. 18, it is assumed that a concealment area A1 represented as a substantially parallelogram is on a plane P1 represented as a substantially parallelogram surrounded by a broken line. The plane P1 is a predetermined plane in a three-dimensional space, and is represented by a plane parameter. The concealment area A1 is a concealment area that has been detected represented by the information acquired from the concealment processing database 64A.

The concealment area search unit 101 maps the concealment area mask onto the three-dimensional space on the basis of the camera posture and the plane parameter associated with the concealment area that has been detected. An area masked by the mapped concealment area mask is the concealment area A1.

Furthermore, the concealment area search unit 101 reprojects the concealment area on the captured image as the processing target using a camera posture T′ of the captured image as the processing target. A frame F1 of a substantially parallelogram in FIG. 18 represents a captured range of a captured image as the processing target.

In a case where at least a part of the concealment area on the plane P1 is reprojected inside the frame F1, the concealment area search unit 101 determines that the concealment area corresponding to the reprojected concealment area is searched in the captured image as the processing target.

In the example of FIG. 18, the concealment area A1 on the plane P1 is reprojected to a concealment area A2 in the frame F1 on the basis of the camera posture T′. In this case, the concealment area A2 is found as the concealment area corresponding to the concealment area A1 that has been detected.

As described above, the concealment area search unit 101 can search the captured image as the processing target for the concealment area in which the area common to the concealment area that has been detected is to be concealed in the captured image after the concealment processing on which the concealment processing for concealing the concealment area has already been performed on the basis of the camera posture of the captured image as the processing target.

Returning to the description of FIG. 17, the concealment area search unit 101 creates a concealment area mask of the searched concealment area. The concealment area search unit 101 supplies the captured image as the processing target and the information regarding the concealment area in association with each other to the concealment processing database 64A for storage therein. The information regarding the concealment area includes the information indicating the camera posture, the plane parameter, and the concealment area mask.

The concealment processing database 64A stores the information supplied from the concealment area search unit 101. Furthermore, the concealment processing database 64A stores a plurality of concealment processing images in advance.

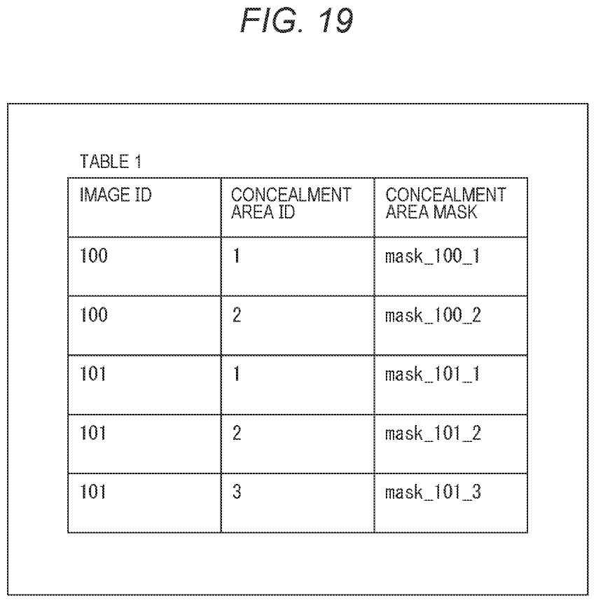

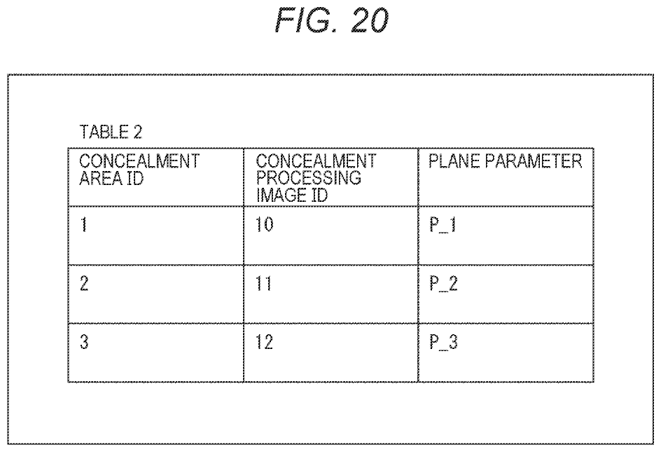

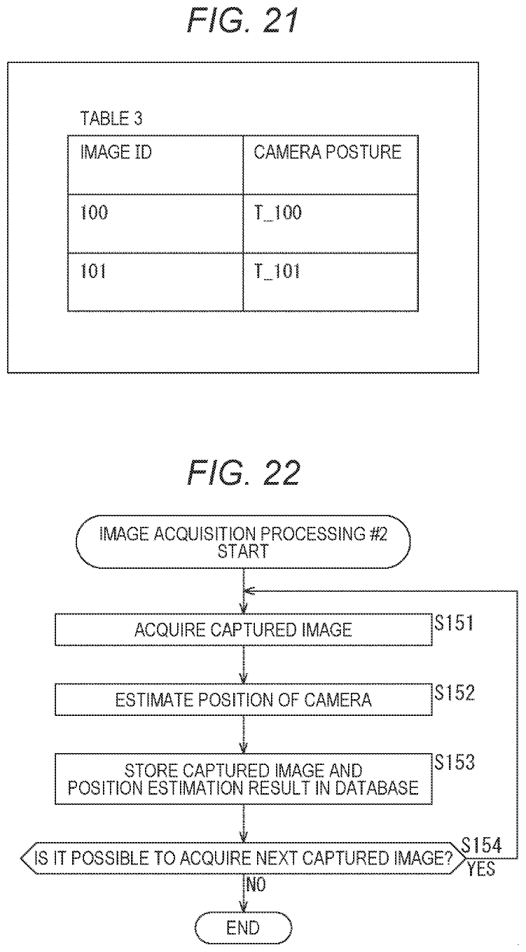

Information managed by the concealment processing database 64A will be described with reference to FIGS. 19 to 21. For example, the concealment processing database 64 stores a table 1 in FIG. 19, a table 2 in FIG. 20, and a table 3 in FIG. 21.

FIG. 19 is a diagram illustrating an example of the table 1 stored in the concealment processing database 64A.

In the table 1 of FIG. 19, “image ID”, “concealment area ID”, and “concealment area mask” are associated with each other.

For example, the concealment area ID 1 given to the area of the letter 71 and the concealment area mask mask_100_1 are associated with the image ID 100.

Furthermore, a concealment area ID 2 and a concealment area mask mask_100_2 are associated with the image ID 100.

Similarly, the concealment area ID and the concealment area mask are associated with the image ID 101.

FIG. 20 is a diagram illustrating an example of the table 2 stored in the concealment processing database 64A.

In the table 2 of FIG. 20, “concealment area ID”, “concealment processing image ID”, and “plane parameter” are associated with each other.

The same ID as the concealment processing image ID described with reference to FIG. 9 is associated with each of the concealment areas ID 1 to ID 3, and the plane parameters P_1 to P_3 are associated with the concealment areas ID 1 to ID 3, respectively. The plane parameter P_1 is a parameter representing a plane in a three-dimensional space to which the letter 71 is mapped. The plane parameters P_2 and P_3 are parameters representing planes in the three-dimensional space where the cover of the book 72 and the cover of the book 73 are mapped, respectively.

FIG. 21 is a diagram illustrating an example of the table 3 stored in the concealment processing database 64A.

In the table 3 of FIG. 21, “image ID” and “camera posture” are associated with each other.

A camera posture T_100 is associated with the image ID 100. A camera posture T_100 represents a camera posture at the time of capturing the captured image with the image ID 100.

A camera posture T_101 is associated with the image ID 101. A camera posture T_101 represents the camera posture at the time of capturing the captured image with the image ID 101.

Returning to the description of FIG. 17, the image synthesis unit 65A acquires, from the concealment processing database 64A, the information regarding the concealment area associated with the image ID of the captured image supplied from the concealment area search unit 101. Specifically, the camera posture, the plane parameter, the concealment area mask, and the concealment processing image are acquired.

The image synthesis unit 65A masks the concealment area included in the captured image supplied from the concealment area search unit 101 using the concealment area mask. Furthermore, the image synthesis unit 65A performs the geometric transformation on the concealment processing image on the basis of the camera posture and the plane parameter, and synthesizes the concealment processing image after the geometric transformation with the captured image. The image synthesis unit 65A supplies the camera posture and the synthesized image obtained by synthesizing the concealment processing image with the captured image to the new concealment area detection unit 66A.

Furthermore, the image synthesis unit 65A synthesizes the concealment processing image with the synthesized image using the concealment area mask and the plane parameters supplied from the new concealment area detection unit 66A, and generates an image after the concealment processing.

Specifically, the image synthesis unit 65A acquires the concealment processing image that is not associated with the concealment area ID in the concealment processing database 64A from the concealment processing database 64A.

The image synthesis unit 65A masks the new concealment area included in the synthesized image as the processing target using the concealment area mask supplied from the new concealment area detection unit 66A. Furthermore, the image synthesis unit 65A performs the geometric transformation on the concealment processing image on the basis of the camera posture and the plane parameter, and synthesizes the concealment processing image with the synthesized image.

The image synthesis unit 65A supplies the concealment processing image synthesized with the synthesized image in association with the information regarding the new concealment area to the concealment processing database 64A for storage therein. The information regarding the new concealment area includes the plane parameter and the concealment area mask. Furthermore, the image synthesis unit 65A supplies the image after the concealment processing to the three-dimensional reconstruction image database 54 (FIG. 16) for storage therein.

The new concealment area detection unit 66A detects the new concealment area included in the synthesized image supplied from the image synthesis unit 65A. The new concealment area detection unit 66A generates information regarding the new concealment area on the basis of the camera posture supplied from the image synthesis unit 65A, and supplies the information to the image synthesis unit 65.

Next, the operation of the smartphone 11A having the above configuration will be described.

Image acquisition processing #2 of the smartphone 11A will be described with reference to a flowchart of FIG. 22.

The process in step S151 is similar to the process in step S51 in FIG. 12. That is, the captured image is acquired by the image acquisition unit 51.

In step S152, the camera posture estimation unit 91 estimates the camera posture at the time of capturing of each captured image on the basis of a plurality of captured images which are the same as the captured image supplied to the image acquisition unit 51.

In step S153, the image acquisition unit 51 supplies the captured image to the posture-attached image database 92 for storage therein. Furthermore, the camera posture estimation unit 91 supplies the information indicating the estimated camera posture to the posture-attached image database 92 for storage therein.

In step S154, the image acquisition unit 51 determines whether or not the next captured image can be acquired.

In a case where it is determined in step S154 that the next captured image can be acquired, the processing returns to step S151, and similar processing is repeatedly performed thereafter.

On the other hand, in a case where it is determined in step S154 that the next captured image cannot be acquired, the processing is terminated.

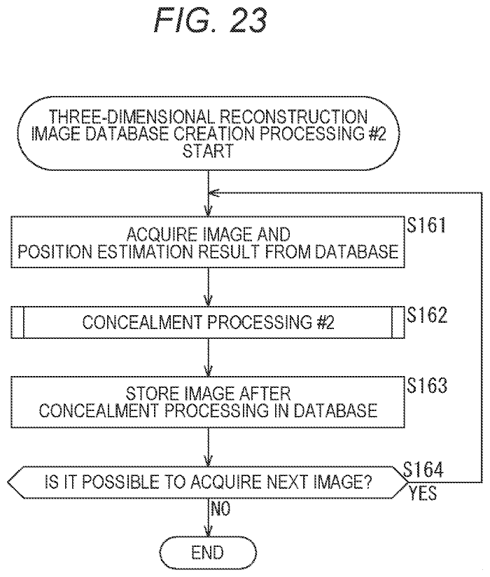

Next, three-dimensional reconstruction image database creation processing #2 of the smartphone 11A will be described with reference to a flowchart of FIG. 23. The three-dimensional reconstruction image database creation processing #2 is processing in which the image after the concealment processing obtained as a result of synthesizing the concealment processing image with the captured image using the camera posture is stored in the three-dimensional reconstruction image database 54.

In step S161, the concealment processing unit 53A acquires the captured image and the camera posture at the time of capturing the captured image from the posture-attached image database 92.

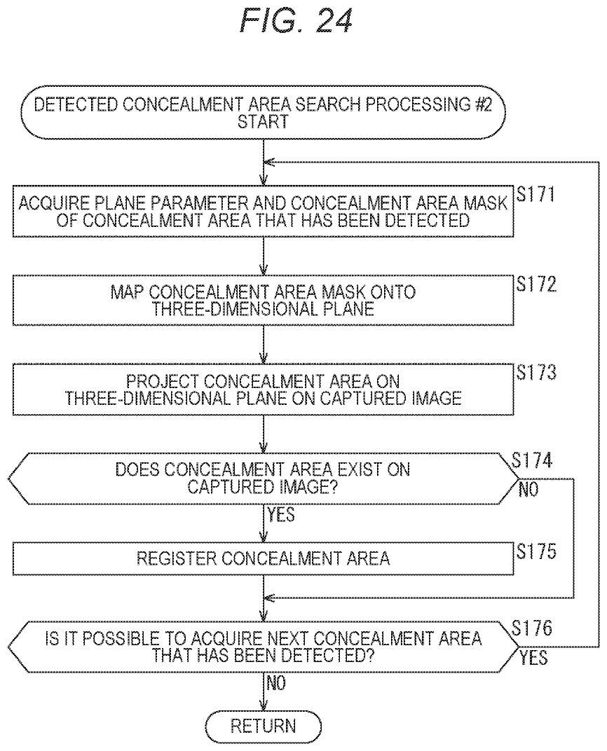

In step S162, the concealment processing unit 53A performs concealment processing #2. By the concealment processing #2, the concealment area is detected from the captured image as the processing target, and an image after the concealment processing is generated. Note that, in the concealment processing #2, processing is performed similarly to the concealment processing #1 described above with reference to the flowchart of FIG. 14, but instead of the detected concealment area search processing #1 in step S71, detected concealment area search processing #2 described later is performed with reference to a flowchart of FIG. 24.

The process in step S163 is similar to the process in step S63 in FIG. 13. That is, the image after the concealment processing is stored in the three-dimensional reconstruction image database 54.

In step S164, the concealment processing unit 53A determines whether or not the next captured image can be acquired.

In a case where it is determined in step S164 that the next captured image can be acquired, the processing returns to step S161, and similar processing is repeatedly performed thereafter.

On the other hand, in a case where it is determined in step S164 that the next captured image cannot be acquired, the processing is terminated.

The detected concealment area search processing #2 in the concealment processing #2 performed in step S162 of FIG. 23 will be described with reference to the flowchart of FIG. 24.

Here, as described with reference to FIG. 14, in the concealment processing #1, the processing of searching for the concealment area corresponding to the concealment area that has been detected included in the captured image as the processing target is performed (step S71). On the other hand, the detected concealment area search processing #2 is processing performed in a case where the camera posture at the time of capturing the captured image is acquired from the posture-attached image database 92.

In step S171, the concealment area search unit 101 acquires information regarding the concealment area that has been detected from the concealment processing database 64A.

In step S172, the concealment area search unit 101 maps the concealment area mask associated with the concealment area that has been detected onto the plane of the three-dimensional space on the basis of the camera posture and the plane parameter associated with the concealment area that has been detected.

In step S173, the concealment area search unit 101 reprojects the concealment area mask mapped onto the plane of the three-dimensional space on the captured image as the processing target using the camera posture at the time of capturing the captured image as the processing target.

In step S174, the concealment area search unit 101 determines whether the concealment area corresponding to the concealment area that has been detected exists on the captured image as the processing target.

In a case where it is determined in step S174 that the concealment area corresponding to the detected concealment area exists on the captured image as the processing target, the processing proceeds to step S175, and the concealment area search unit 101 creates the concealment area mask of the searched concealment area. The concealment area search unit 101 supplies the captured image as the processing target and the information regarding the concealment area in association with each other to the concealment processing database 64A for storage therein. Thereafter, the processing proceeds to step S176.

On the other hand, in a case where it is determined in step S174 that the concealment area corresponding to the concealment area that has been detected does not exist in the captured image as the processing target, processing of step S175 is skipped, and the processing proceeds to step S176.

In step S176, the concealment area search unit 101 determines whether or not the next concealment area that has been detected can be acquired.

In a case where it is determined in step S176 that the next concealment area that has been detected can be acquired, the processing returns to step S171, and similar processing is repeatedly performed thereafter.

On the other hand, in a case where it is determined in step S176 that the next concealment area that has been detected cannot be acquired, the processing returns to step S71 in FIG. 14, and the subsequent processing is performed.

With the above processing, it is possible to assign the camera posture to each acquired captured image and calculate a relative relationship between the camera postures obtained by capturing each captured image.

Furthermore, it is possible to perform a robust search for the concealment area corresponding to the concealment area that has been detected without depending on the accuracy of detection of the feature point, calculation of the feature amount, and matching of the feature points.

<5. Example Using Text Area>

The geometric transformation parameter may be estimated using the text area detected from the image.

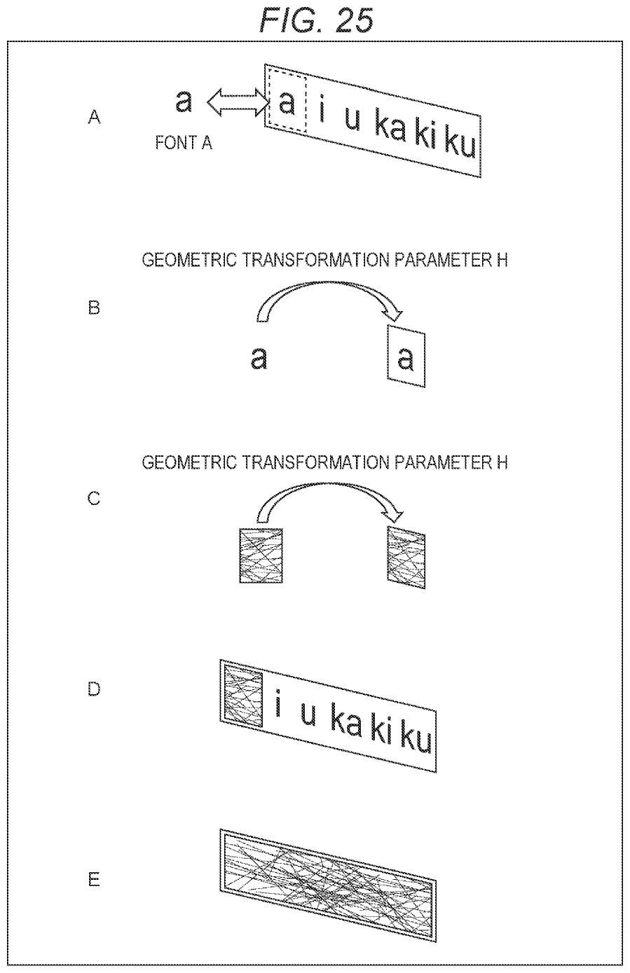

FIG. 25 is a diagram illustrating a method of estimating a geometric transformation parameter using the text area.

As illustrated in A of FIG. 25, the smartphone 11 detects, for example, a text area from the captured image, and performs character identification processing and font identification processing on the text area. In the example in A of FIG. 25, the text area including the characters “a, i, u, ka, ki, ku” is detected.

The character identification processing is processing of identifying a character appearing in the text area. By the character identification processing, for example, the character “a” surrounded by a broken line in A of FIG. 25 is identified. The font identification processing is processing of identifying the font of a character. By the font identification processing, for example, the font of the character “a” is identified. Here, a disclosed technology (for example, Japanese Patent Application Laid-Open No. 2016-31709, Japanese Patent Application Laid-Open No. 2013-73439, Japanese Patent Application Laid-Open No. 2011-18175, and the like) can be applied to the character identification processing and the font identification processing.

As illustrated in B of FIG. 25, the smartphone 11 acquires a facing text image, which is an image of a character of the identified font viewed from the front, from the database. For example, in a database managed by the smartphone 11, facing text images of respective characters of respective fonts are prepared.

The smartphone 11 estimates a geometric transformation parameter H for geometrically transforming the facing text image in accordance with an orientation of the identified character in the text area. The smartphone 11 converts the facing text image of each character into a feature amount in advance, and estimates the geometric transformation parameter H by matching the identified character with the facing text image on the basis of the feature amount.

As illustrated in C of FIG. 25, the smartphone 11 performs the geometric transformation on the concealment processing image using the geometric transformation parameter H. Thus, the concealment processing image is deformed in accordance with the orientation of the identified character in the text area.

As illustrated in D of FIG. 25, the smartphone 11 synthesizes the concealment processing image subjected to the geometric transformation on the text area of the captured image.

As illustrated in E of FIG. 25, in a case where a plurality of characters is detected in the same text area, the geometric transformation parameters estimated for the respective characters are integrated, and the concealment processing image is synthesized so as to conceal all the characters. Furthermore, instead of integrating the estimated geometric transformation parameters, an optimal parameter may be employed and the concealment processing image may be synthesized.

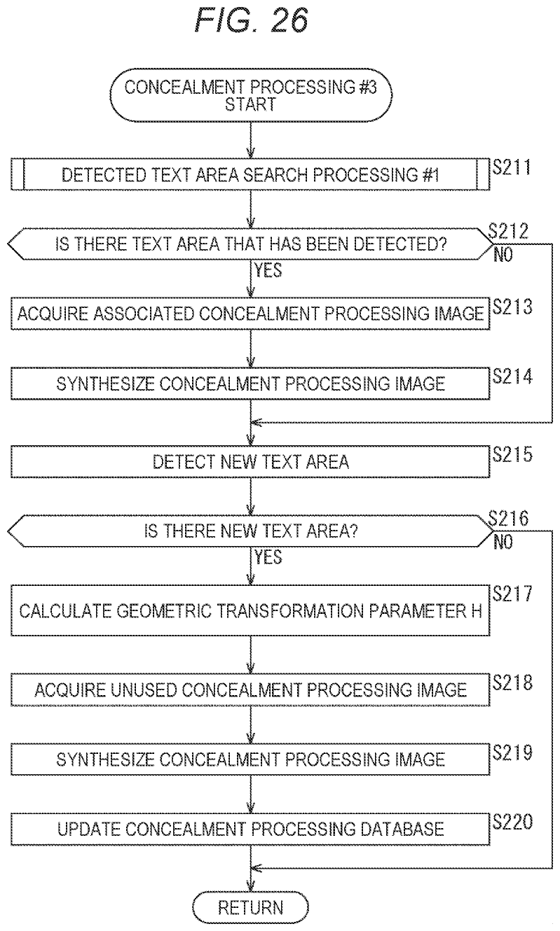

Concealment processing #3 in three-dimensional reconstruction image database creation processing #3 of the smartphone 11 will be described with reference to a flowchart of FIG. 26. The three-dimensional reconstruction image database creation processing #3 is processing in which the image after the concealment processing obtained as a result of synthesizing the concealment processing image with the text area in the captured image is stored in the three-dimensional reconstruction image database 54.

Here, as described with reference to FIG. 13, in the three-dimensional reconstruction image database creation processing #1, processing of detecting the concealment area of the captured image as the processing target and generating the image after the concealment processing is performed (step S62). On the other hand, concealment processing #3 is processing performed in a case where, for example, a group of captured images in which the concealment area includes only the text area is acquired.

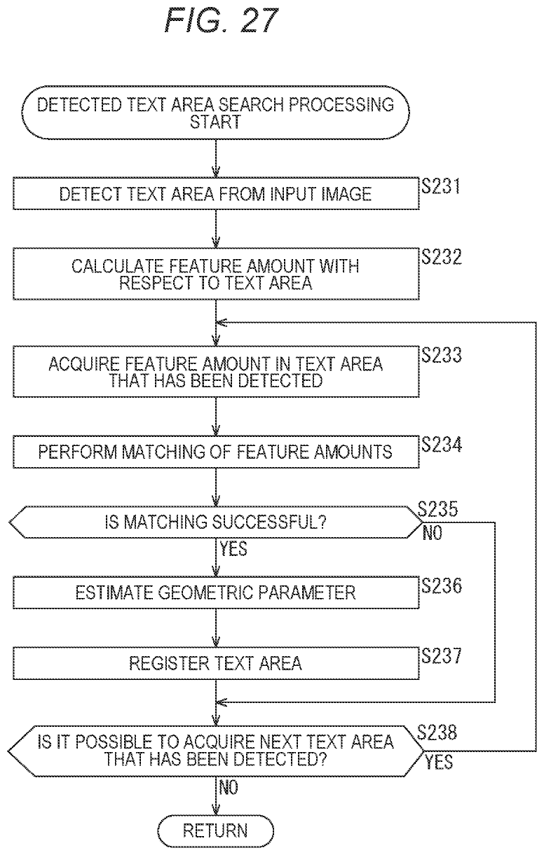

In step S211, the concealment processing unit 53 performs detected text area search processing. By the detected text area search processing, the text area corresponding to the text area that has been detected included in the captured image as the processing target is found. Note that the detected text area search processing will be described later with reference to a flowchart of FIG. 27.

In step S212, the image synthesis unit 65 determines whether or not the text area corresponding to the text area that has been detected is in the captured image as the processing target according to a search result in step S211.

In a case where it is determined in step S212 that the text area corresponding to the text area that has been detected is in the captured image as the processing target, the processing proceeds to step S213, and the image synthesis unit 65 acquires the concealment processing image associated with the found text area from the concealment processing database 64 together with the information regarding the concealment area.

In step S214, the image synthesis unit 65 masks the text area included in the captured image using the concealment area mask, and performs the geometric transformation on the concealment processing image using the geometric transformation parameter. Moreover, the image synthesis unit 65 synthesizes the concealment processing image subjected to the geometric transformation with the captured image to generate a synthesized image. The image synthesis unit 65 supplies the synthesized image to the new concealment area detection unit 66, and the processing proceeds to step S215.

On the other hand, in a case where it is determined in step S212 that the text area corresponding to the text area that has been detected is not in the captured image, processing of steps S213 and S214 is skipped, and the processing proceeds to step S215.

In step S215, the new concealment area detection unit 66 detects a new text area, which is a text area included in the synthesized image and not registered in the concealment processing database 64.

In step S216, the new concealment area detection unit 66 determines whether or not the new text area exists in the synthesized image according to the detection result in step S215.

In a case where it is determined in step S216 that the new concealment area exists, the processing proceeds to step S217, and the new concealment area detection unit 66 calculates the geometric transformation parameter H as described above with reference to FIG. 25. Furthermore, the new concealment area detection unit 66 creates the concealment area mask of the detected new concealment area. The new concealment area detection unit 66 supplies the geometric transformation parameter H and the concealment area mask corresponding to the detected text area to the image synthesis unit 65.

The processes in steps S218 to S220 are similar to the processes in steps S77 to S79 in FIG. 14.

On the other hand, in a case where it is determined in step S216 that there is no new text area, the processing returns to step S62 in FIG. 13, and the subsequent processing is performed.

The detected text area search processing performed in step S211 of FIG. 26 will be described with reference to the flowchart of FIG. 27.

In step S231, the feature point detection unit 61 detects a text area in the captured image as the processing target. The feature point detection unit 61 detects a character included in the detected text area as a feature point.

In step S232, the feature point detection unit 61 calculates a feature amount for the detected character. The feature point detection unit 61 supplies information indicating the feature amount of each character in the text area and the captured image to the matching unit 62.

In step S233, the matching unit 62 acquires the feature amount of the character included in the text area that has been detected from the concealment processing database 64. Note that as the feature amount of the character included in the text area that has been detected, the feature amount of the facing text image of the character included in the text area that has been detected is stored in the concealment processing database 64.

In step S234, the matching unit 62 performs matching between the character included in the text area in the captured image and the character included in the text area that has been detected on the basis of the respective feature amounts.

In step S235, the matching unit 62 determines whether or not the matching of the characters is successful.

In a case where it is determined in step S235 that the matching of feature points is successful, the processing proceeds to step S236.

In step S236, the matching unit 62 supplies the corresponding feature point information and the captured image to the geometric transformation parameter estimation unit 63. The geometric transformation parameter estimation unit 63 estimates the geometric transformation parameter H on the basis of the corresponding feature point information. The geometric transformation parameter estimation unit 63 generates the concealment area mask using the estimated geometric transformation parameter H.

In step S237, the geometric transformation parameter estimation unit 63 supplies the captured image as the processing target and the information regarding the concealment area in association with each other to the concealment processing database 64 for storage therein. Thereafter, the processing proceeds to step S238.

On the other hand, in a case where it is determined in step S235 that the matching of the characters has failed, processing of steps S236 and S237 is skipped, and the processing proceeds to step S238.

In step S238, the matching unit 62 determines whether or not the next text area that has been detected can be acquired.

In a case where it is determined in step S238 that the next text area that has been detected can be acquired, the processing returns to step S233, and similar processing is repeatedly performed thereafter.

On the other hand, in a case where it is determined in step S238 that the next text area that has been detected cannot be acquired, the geometric transformation parameter estimation unit 63 supplies the captured image to the image synthesis unit 65. Thereafter, the processing returns to step S211 in FIG. 26, and the subsequent processing is performed.

Through the above processing, the smartphone 11 can generate an image in which the text area is concealed. By concealing only the text area, it is possible to perform the concealment processing more precisely in accordance with the shape of the concealment area. Furthermore, accuracy of the three-dimensional reconstruction can be improved.

<6. Others>

The series of processes described above can be executed by hardware or can be executed by software. In a case where the series of processing is executed by software, a program constituting the software is installed on a computer built into dedicated hardware, a general-purpose personal computer, or the like.

The program to be installed is provided by being recorded in the removable medium 44 illustrated in FIG. 3 including an optical disk (compact disc-read only memory (CD-ROM), digital versatile disc (DVD), or the like), a semiconductor memory, and the like. Furthermore, the information may be provided via a wired or wireless transmission medium such as a local area network, the Internet, or digital broadcasting. The program can be installed in the ROM 32 or the memory 41 in advance.

Note that the program executed by the computer may be a program for processing in time series in the order described in the present description, or a program for processing in parallel or at a necessary timing such as when a call is made.

Note that in the present description, a system means a set of a plurality of components (devices, modules (parts), and the like), and it does not matter whether or not all the components are in the same housing. Therefore, both of a plurality of devices housed in separate housings and connected via a network and a single device in which a plurality of modules is housed in one housing are systems.

Note that the effects described herein are merely examples and are not limited, and other effects may be provided.

The embodiments of the present technology are not limited to the above-described embodiments, and various modifications are possible without departing from the gist of the present technology.

For example, the present technology can employ a configuration of cloud computing in which one function is shared by a plurality of devices via a network and processed jointly.

Furthermore, each step described in the above-described flowcharts can be executed by one device, or can be executed in a shared manner by a plurality of devices.

Moreover, in a case where a plurality of processes is included in one step, the plurality of processes included in the one step can be executed in a shared manner by a plurality of devices in addition to being executed by one device.

<Example of Combinations of Configurations>

The present technology can also employ the following configurations.

(1)

An image processing device including:

a control unit that

searches an image among a plurality of images in which a same subject is captured, in which the image is a processing target that is a target of processing of searching for a concealment area that is an area to be concealed in the image, for the concealment area in which an area common to the concealment area that has been detected is to be concealed in the image after concealment processing for which concealment processing to conceal the concealment area has already been performed, and

synthesizes, when a concealment processing image including a unique texture is synthesized with the concealment area that has been found from the image as the processing target, the concealment processing image that is same as the concealment processing image synthesized by concealment processing on the concealment area that has been detected, with the concealment area in the image as the processing target in which an area common to the concealment area that has been detected is to be concealed.

(2)

The image processing device according to (1) above, in which

a plurality of the images is images in which the same subject is captured from different positions.

(3)

The image processing device according to (1) or (2) above, in which

the control unit transmits a plurality of the images after concealment processing subject to concealment processing of synthesizing with the concealment processing image and concealing the concealment area to another device that creates three-dimensional information of the subject using the plurality of the images, and

the another device generates the three-dimensional information of the subject on the basis of a correspondence relationship of feature points in the plurality of the images.

(4)

The image processing device according to any one of (1) to (3) above, in which

in a case where a plurality of the concealment areas is found in the image as the processing target, the control unit synthesizes the concealment processing images having different unique textures from each other with respect to the respective concealment areas.

(5)

The image processing device according to any one of (1) to (4) above, in which

the concealment area is an area including privacy information regarding an individual.

(6)

The image processing device according to (5) above, in which

the concealment area is a text area including a text describing the privacy information or an area to which a semantic label is given as the privacy information.

(7)

The image processing device according to any one of (1) to (6) above, in which

the concealment processing image includes a texture in which a same texture pattern does not repeatedly appear in one of the concealment processing images and a texture pattern common to the other concealment processing images does not exist.

(8)

The image processing device according to any one of (1) to (7) above, in which

the control unit

estimates a geometric transformation parameter used to deform the concealment processing image in accordance with a shape of the concealment area on the image as the processing target, and

deforms the concealment processing image using the geometric transformation parameter and synthesizes the deformed concealment processing image with the concealment area.

(9)

The image processing device according to (8) above, in which

the control unit estimates, for the concealment area in which a common area is to be concealed, the geometric transformation parameter used to deform the concealment processing image with respect to the concealment area as the processing target on the basis of a geometric relationship with the concealment area that has been detected.

(10)

The image processing device according to (8) or (9) above, in which

the control unit

detects a feature point representing a point to be a feature in the image having the concealment area, and

estimates the geometric transformation parameter on the basis of the feature point in the image after the concealment processing and the feature point in the image as the processing target.

(11)

The image processing device according to any one of (1) to (7) above, in which

the control unit

estimates a posture of a camera that has captured the subject at a time of capturing on the basis of each of the plurality of the images, and

searches the image as the processing target for the concealment area that conceals an area common to the concealment area in the image after the concealment processing on the basis of the posture of the camera at the time of capturing.

(12)

The image processing device according to (11) above, in which

the control unit

maps the concealment area that has been detected on a plane in which a subject concealed by the concealment area that has been detected in the image after the concealment processing is arranged in a three-dimensional space on the basis of the posture of the camera at a time of capturing the image after the concealment processing, and

searches for an area in which the subject concealed by the concealment area that has been detected appearing in the image as the processing target by projecting the concealment area that has been detected mapped on the plane in the three-dimensional space onto a plane representing a captured range of the image as the processing target on the basis of the posture of the camera at the time of capturing the image as the processing target.

(13)

The image processing device according to (8) above, in which

the concealment area is a text area including a text, and

the control unit

searches the image as the processing target for the text area common to the text area that has been detected in the image after the concealment processing, and

estimates the geometric transformation parameter that deforms a facing text image, which is an image of the text included in the text area as viewed from a front, according to an orientation of the text included in the text area.

(14)

An image processing method including, by an image processing device:

searching an image among a plurality of images in which a same subject is captured, in which the image is a processing target that is a target of processing of searching for a concealment area that is an area to be concealed in the image, for the concealment area in which an area common to the concealment area that has been detected is to be concealed in the image after concealment processing for which concealment processing to conceal the concealment area has already been performed, and

synthesizing, when a concealment processing image including a unique texture is synthesized with the concealment area that has been found from the image as the processing target, the concealment processing image that is same as the concealment processing image synthesized by concealment processing on the concealment area that has been detected, with the concealment area in the image as the processing target in which an area common to the concealment area that has been detected is to be concealed.

(15)

A program for causing a computer to execute processing including:

searching an image among a plurality of images in which a same subject is captured, in which the image is a processing target that is a target of processing of searching for a concealment area that is an area to be concealed in the image, for the concealment area in which an area common to the concealment area that has been detected is to be concealed in the image after concealment processing for which concealment processing to conceal the concealment area has already been performed, and

synthesizing, when a concealment processing image including a unique texture is synthesized with the concealment area that has been found from the image as the processing target, the concealment processing image that is same as the concealment processing image synthesized by concealment processing on the concealment area that has been detected, with the concealment area in the image as the processing target in which an area common to the concealment area that has been detected is to be concealed.

(16)

An image processing system including:

an image processing device that includes a control unit that

searches an image among a plurality of images in which a same subject is captured, in which the image is a processing target that is a target of processing of searching for a concealment area that is an area to be concealed in the image, for the concealment area in which an area common to the concealment area that has been detected is to be concealed in the image after concealment processing for which concealment processing to conceal the concealment area has already been performed,

synthesizes, when a concealment processing image including a unique texture is synthesized with the concealment area that has been found from the image as the processing target, the concealment processing image that is same as the concealment processing image synthesized by concealment processing on the concealment area that has been detected, with the concealment area in the image as the processing target in which an area common to the concealment area that has been detected is to be concealed, and

transmits a plurality of the images after concealment processing subject to concealment processing of synthesizing with the concealment processing image and concealing the concealment area;

a front-end server that receives the plurality of the images after concealment processing; and

a back-end server that creates three-dimensional information of the subject using the plurality of the images after concealment processing.

### REFERENCE SIGNS LIST

1 Image processing system
11 Smartphone
12 Front-end server
13 Back-end server
14 Network
51 Image acquisition unit
52 Image database
53 Concealment processing unit
54 Three-dimensional reconstruction image database
55 Transmission unit
61 Feature point detection unit
62 Matching unit
63 Geometric transformation parameter estimation unit
64 Concealment processing database
65 Image synthesis unit
66 New concealment area detection unit
91 Camera posture estimation unit
92 Posture-attached image database
101 Concealment area search unit

1. An image processing device comprising
a control unit that
searches an image among a plurality of images in which a same subject is captured, in which the image is a processing target that is a target of processing of searching for a concealment area that is an area to be concealed in the image, for the concealment area in which an area common to the concealment area that has been detected is to be concealed in the image after concealment processing for which concealment processing to conceal the concealment area has already been performed, and
synthesizes, when a concealment processing image including a unique texture is synthesized with the concealment area that has been found from the image as the processing target, the concealment processing image that is same as the concealment processing image synthesized by concealment processing on the concealment area that has been detected, with the concealment area in the image as the processing target in which an area common to the concealment area that has been detected is to be concealed.

2. The image processing device according to claim 1, wherein
a plurality of the images is images in which the same subject is captured from different positions.

3. The image processing device according to claim 1, wherein
the control unit transmits a plurality of the images after concealment processing subject to concealment processing of synthesizing with the concealment processing image and concealing the concealment area to another device that creates three-dimensional information of the subject using the plurality of the images, and
the another device generates the three-dimensional information of the subject on a basis of a correspondence relationship of feature points in the plurality of the images.

4. The image processing device according to claim 1, wherein
in a case where a plurality of the concealment areas is found in the image as the processing target, the control unit synthesizes the concealment processing images having different unique textures from each other with respect to the respective concealment areas.

5. The image processing device according to claim 1, wherein
the concealment area is an area including privacy information regarding an individual.

6. The image processing device according to claim 5, wherein
the concealment area is a text area including a text describing the privacy information or an area to which a semantic label is given as the privacy information.

7. The image processing device according to claim 1, wherein
the concealment processing image includes a texture in which a same texture pattern does not repeatedly appear in one of the concealment processing images and a texture pattern common to the other concealment processing images does not exist.

8. The image processing device according to claim 1, wherein
the control unit
estimates a geometric transformation parameter used to deform the concealment processing image in accordance with a shape of the concealment area on the image as the processing target, and
deforms the concealment processing image using the geometric transformation parameter and synthesizes the deformed concealment processing image with the concealment area.

9. The image processing device according to claim 8, wherein
the control unit estimates, for the concealment area in which a common area is to be concealed, the geometric transformation parameter used to deform the concealment processing image with respect to the concealment area as the processing target on a basis of a geometric relationship with the concealment area that has been detected.

10. The image processing device according to claim 9, wherein
the control unit
detects a feature point representing a point to be a feature in the image having the concealment area, and
estimates the geometric transformation parameter on a basis of the feature point in the image after the concealment processing and the feature point in the image as the processing target.

11. The image processing device according to claim 1, wherein
the control unit
estimates a posture of a camera that has captured the subject at a time of capturing on a basis of each of the plurality of the images, and
searches the image as the processing target for the concealment area that conceals an area common to the concealment area in the image after the concealment processing on a basis of the posture of the camera at the time of capturing.

12. The image processing device according to claim 11, wherein
the control unit
maps the concealment area that has been detected on a plane in which a subject concealed by the concealment area that has been detected in the image after the concealment processing is arranged in a three-dimensional space on a basis of the posture of the camera at a time of capturing the image after the concealment processing, and
searches for an area in which the subject concealed by the concealment area that has been detected appearing in the image as the processing target by projecting the concealment area that has been detected mapped on the plane in the three-dimensional space onto a plane representing a captured range of the image as the processing target on a basis of the posture of the camera at the time of capturing the image as the processing target.

13. The image processing device according to claim 8, wherein
the concealment area is a text area including a text, and
the control unit
searches the image for the text area common to the text area that has been detected in the image after the concealment processing, and
estimates the geometric transformation parameter that deforms a facing text image, which is an image of the text included in the text area as viewed from a front, according to an orientation of the text included in the text area.

14. An image processing method comprising, by an image processing device:
searching an image among a plurality of images in which a same subject is captured, in which the image is a processing target that is a target of processing of searching for a concealment area that is an area to be concealed in the image, for the concealment area in which an area common to the concealment area that has been detected is to be concealed in the image after concealment processing for which concealment processing to conceal the concealment area has already been performed, and
synthesizing, when a concealment processing image including a unique texture is synthesized with the concealment area that has been found from the image as the processing target, the concealment processing image that is same as the concealment processing image synthesized by concealment processing on the concealment area that has been detected, with the concealment area in the image as the processing target in which an area common to the concealment area that has been detected is to be concealed.

15. A program for causing a computer to execute processing comprising:
searching an image among a plurality of images in which a same subject is captured, in which the image is a processing target that is a target of processing of searching for a concealment area that is an area to be concealed in the image, for the concealment area in which an area common to the concealment area that has been detected is to be concealed in the image after concealment processing for which concealment processing to conceal the concealment area has already been performed, and
synthesizing, when a concealment processing image including a unique texture is synthesized with the concealment area that has been found from the image as the processing target, the concealment processing image that is same as the concealment processing image synthesized by concealment processing on the concealment area that has been detected, with the concealment area in the image as the processing target in which an area common to the concealment area that has been detected is to be concealed.

16. An image processing system comprising:
an image processing device that includes a control unit that
searches an image among a plurality of images in which a same subject is captured, in which the image is a processing target that is a target of processing of searching for a concealment area that is an area to be concealed in the image, for the concealment area in which an area common to the concealment area that has been detected is to be concealed in the image after concealment processing for which concealment processing to conceal the concealment area has already been performed,
synthesizes, when a concealment processing image including a unique texture is synthesized with the concealment area that has been found from the image as the processing target, the concealment processing image that is same as the concealment processing image synthesized by concealment processing on the concealment area that has been detected, with the concealment area in the image as the processing target in which an area common to the concealment area that has been detected is to be concealed, and
transmits a plurality of the images after concealment processing subject to concealment processing of synthesizing with the concealment processing image and concealing the concealment area;
a front-end server that receives the plurality of the images after concealment processing; and
a back-end server that creates three-dimensional information of the subject using the plurality of the images after concealment processing.
